(19) United States
(12) Patent Application Publication
(10) Pub. No.: US 2016/0094868 A1
(43) Pub. Date: Mar. 31, 2016

(54) METHOD AND SYSTEM FOR AUTOMATIC SELECTION OF CHANNEL LINE UP, SET TOP BOX (STB) IR CODES, AND PAY TV OPERATOR FOR TELEVISIONS CONTROLLING AN STB

(71) Applicant: Samsung Electronics Co., Ltd., Suwon-si (KR)

(72) Inventors: Ashish Singhal, Irvine, CA (US); Feng Xu, Irvine, CA (US); Praveen Kashyap, Irvine, CA (US); Jing Zhang, Irvine, CA (US)

(21) Appl. No.: 14/502,871

(22) Filed: Sep. 30, 2014

(51) Int. Cl. H04N 21/426; H04N 21/422; H04N 21/435; H04N 21/266; H04N 21/431; H04N 21/418; H04N 21/458

(52) U.S. Cl. CPC H04N 21/4263; H04N 21/4182; H04N 21/42207; H04N 21/4221; H04N 21/42221; H04N 21/458; H04N 21/266; H04N 21/42684; H04N 21/4314; H04N 21/435

(57) ABSTRACT

A method includes automatically identifying a multi-channel video programming distributor (MVPD) using an electronic device and automatically determining infrared (IR) codes for a set top box (STB) device connected to the electronic device. The STB device receives information from the MPVD.

### TECHNICAL FIELD

One or more embodiments relate generally to television networks and, in particular, to automatically determining a multi-channel video programming distributor (MVPD), infrared (IR) code for a set top box (STB), a channel lineup and creating channel banner templates.

### BACKGROUND

Television devices may include proprietary applications that provide a user the ability to watch Linear TV using the proprietary application experience and remote control. However, to enable the proprietary functionality, the user has to provide information including their Pay TV operator, set top box (STB) manufacturer and model number, channel lineup, subscription package, etc. Much of this information is not known to the user (or may be difficult to find out).

### SUMMARY

In one embodiment, a method includes automatically identifying a multi-channel video programming distributor (MVPD) using an electronic device and automatically determining infrared (IR) codes for a set top box (STB) device connected to the electronic device. The STB device receives information from the MPVD.

Another embodiment provides a method that includes automatically identifying a MVPD using an electronic device. The method further includes automatically determining a channel lineup for an STB device that receives information from the MPVD.

Another embodiment provides a method that includes receiving video frames by a server device. The method further determines if the received video frames contain a channel banner. It is determined if one or more determined channel banners are a match with one or more existing templates. A matched template is downloaded to an electronic device. A channel banner template is automatically created if a match is not determined to exist.

Still another embodiment provides a method that includes automatically creating a channel banner template for one or more received images if required. An MVPD is automatically identified using an electronic device based on using the created banner template if required. IR codes for an STB device connected to the electronic device are automatically determined. A channel lineup for the STB device is automatically determined. The STB device receives information from the MPVD.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows an example cable headend and receiver hierarchy.

FIG. 2 shows a block diagram of a TV device in which embodiments are implemented in an access module, according to an embodiment.

FIG. 3 shows an example distributed system that may implement one or more embodiments.

FIG. 4 shows a flow diagram for automatically determining a correct pay TV operator and IR codes, according to an embodiment.

FIG. 5 shows an example MVPD channel banner.

FIG. 6 shows a hierarchy of device and key code sets for multiple STBs, according to an embodiment.

FIG. 7 shows a flow diagram for automatic MPVD determination, according to an embodiment.

FIG. 8 shows a flow diagram for classifying of MPVDs, according to an embodiment.

FIG. 9 shows examples of screenshots, associated banners and extraction of a global feature, according to an embodiment.

FIG. 10 shows a flow diagram for binary classification of MPVDs, according to an embodiment.

FIG. 11 shows a flow diagram for local classification of MPVDs, according to an embodiment.

FIG. 12 shows a flow diagram for key differentiating points (KDP) matching, according to an embodiment.

FIG. 13 shows an example channel banner with KDPs shown as marked, according to an embodiment.

FIGS. 14A-C show examples of screenshots with KDPs marked on banner portions, according to an embodiment.

FIG. 15 shows an example key value pair vector, according to an embodiment.

FIG. 16 shows a flow diagram for template matching, according to an embodiment.

FIG. 17 shows a flow diagram for automatically determining a correct pay TV operator and channel lineup, according to an embodiment

FIG. 18 shows an example screenshot of an unsubscribed channel.

FIG. 19 shows an example template for a channel banner, according to an embodiment.

FIG. 20 shows an example system for automatically creating channel banner templates, according to an embodiment.

FIG. 21 shows an example system flow for automatically creating channel banner templates, according to an embodiment.

FIG. 22 shows an example flow diagram for automatically creating channel banner templates, according to an embodiment.

FIG. 23 shows an example flow diagram for determining if video buffer images contain a channel template or not, according to an embodiment.

FIG. 24 shows example images with channel banners and a difference image.

FIG. 25 shows a block diagram for an image search engine used for automatically creating channel banner templates, according to an embodiment.

FIG. 26 shows a flow diagram for automatic channel banner template shape generation, according to an embodiment.

FIG. 27 shows a flow diagram for automatic channel information location generation, according to an embodiment.

FIGS. 28A-D show examples of images and associated cropped images, according to an embodiment.

FIG. 29 shows an example averaged image of cropped images, according to an embodiment.

FIG. 30 shows an example image with detected lines, according to an embodiment.

FIG. 31 shows an example image with detected corners, according to an embodiment.

FIG. 32 shows an example channel banner template image generated from detected corners and lines, according to an embodiment.

FIGS. 33A-C show examples of binary template-shape cropped images, according to an embodiment.

FIG. 34 shows an example histogram of different portions within a channel banner, according to an embodiment.

FIG. 35 shows coordinates for masking areas for the histogram of FIG. 34, according to an embodiment.

FIG. 36 shows another example histogram of different portions within a channel banner, according to an embodiment.

FIG. 37 shows coordinates for masking areas for the histogram of FIG. 36, according to an embodiment.

FIGS. 38A-B show examples of final channel banner templates that were automatically created, according to an embodiment.

FIG. 39 is a high level block diagram showing a computing system useful for implementing an embodiment.

FIG. 40 is a flow diagram, according to an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments of relate generally to automatically determining an MPVD, IR code for an STB, a channel lineup and creating channel banner templates. One embodiment includes a method that automatically identifies a multi-channel video programming distributor (MVPD) using an electronic device (e.g., a television (TV) device) and automatically determines infrared (IR) codes for a set top box (STB) device connected to the electronic device. The STB device receives information from the MPVD.

An MVPD is a service provider that delivers video programming services, usually for a subscription fee (pay TV). These operators include TV (CATV) systems, direct-broadcast satellite (DBS) providers, and wireline video providers and competitive local exchange carriers (CLECs) using IPTV. Section 602 of The Communications Act of 1934 (as amended by the Telecommunications Act of 1996) defines an MVPD as a person such as, but not limited to, a cable operator, a multichannel multipoint distribution service, a direct broadcast satellite service, or a television receive-only satellite program distributor, who makes available for purchase, by subscribers or customers, multiple channels of video programming.

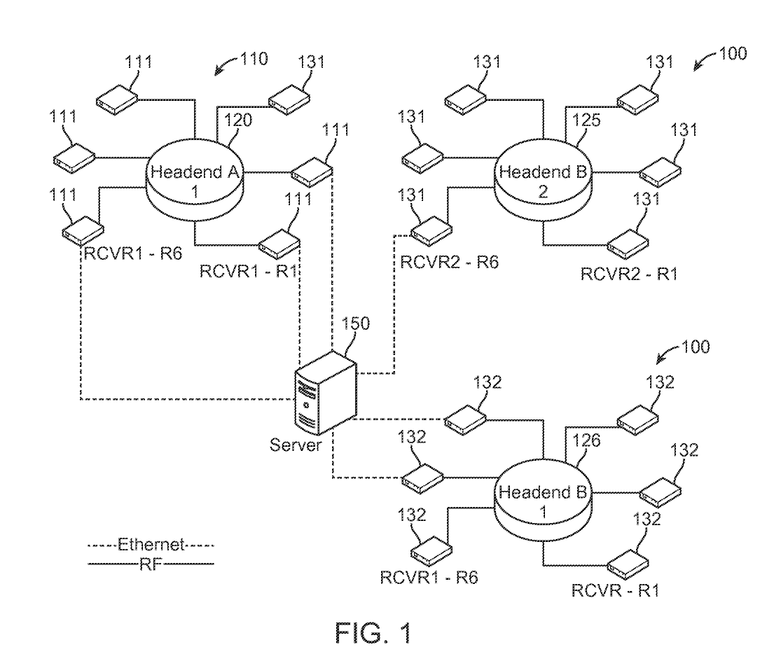

FIG. 1 shows an example cable headend and receiver hierarchy. Headend A 1 120 in a provider network or cable plant 110 is connected with several receivers 111 (Rcvr1 R1-R6); headend B 1 126 in a provider network or cable plant 100 is connected to several receivers 132 (Rcvr1 R1-R6); and headend B 2 125 in an additional provider network or cable plant 100 is connected with several receivers 131 (Rcvr2 R1-R6). The number of receivers on a headend is not known a priori and the number can change at any time. Also, the network connection is not guaranteed and the receiver STB or other type of receiver, or the network can fail at any time.

The channel maps for provided content and other cable plant information for all receivers on one headend is the same (e.g., all receivers 111 on headend A 1 120 have the same channel map, all the receivers 132 on headend B 1 126 have the same channel map, etc.). A channel map includes a table of channel information of all available channels in a cable headend system. Each channel information may include the following:
(1) Virtual channel number: up to 4-digit solid number for Cable (2, 1015, etc.) or combination of major and minor numbers for ATSC (7.1, 123.456, etc.);
(2) channel name or call sign: e.g., KCBS, CNN, ESPN2 HD, etc.;
(3) physical channel number: a 3-digit number which defines the tuning frequency to select a multiplex, or transport stream;
(4) program number: a 16-bit number to select a program (a TV channel) from the multiplex; and
(5) Modulation type (QAM 256, VSB 8, etc.).

The changes to the cable plant information are simultaneously reflected in all its receivers. The receivers 111, 131 and 132 and the network connectivity with the respective headends may be unreliable due to congestion, failures, etc. In one embodiment, a server or service 150 may be connected to particular or all receivers 111, 131 and 132 for receiving information and assigning priorities.

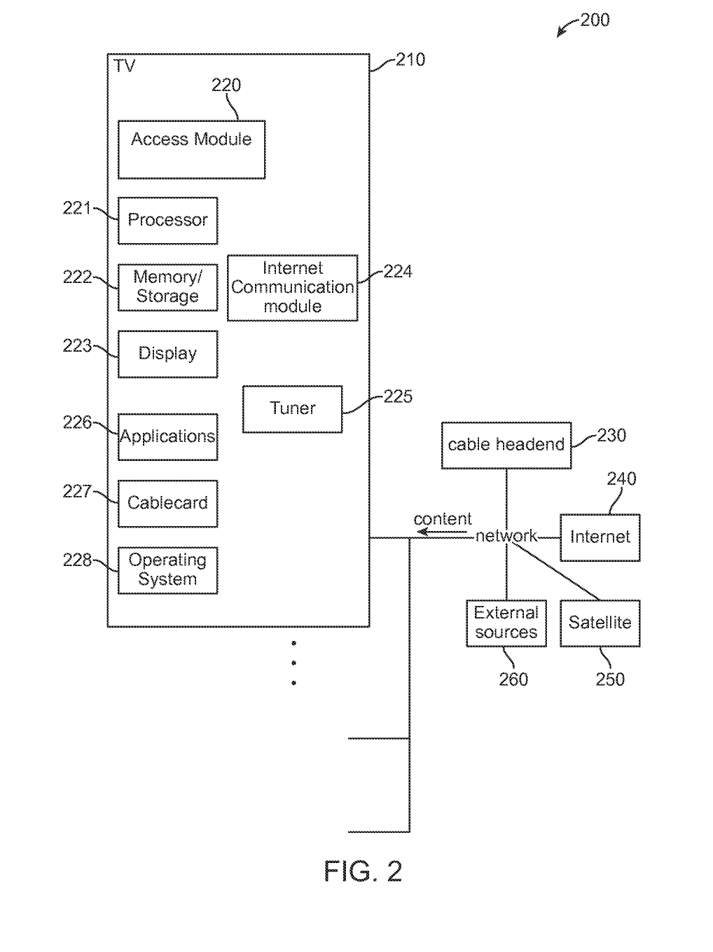

FIG. 2 shows a block diagram 200 of a TV device 210 in which embodiments are implemented in an access module, according to an embodiment. The TV device 210 may be connected in a home or local network with other devices. In one embodiment, the TV device 210 includes an access module 220 that may include processes similar to the flow diagrams described below. In one embodiment, the TV device 210 further includes a processor device 221, a memory/storage device 222, a display 223, one or more applications 226, an Internet communication module 224, a tuner 225, a cable card (or similar device) 227, an operating system 228, etc. In one example, the TV device 210 may connected over a network to the cable headend 230, the Internet 240, a satellite 250, external sources 260, and server 150 (FIG. 1), etc.

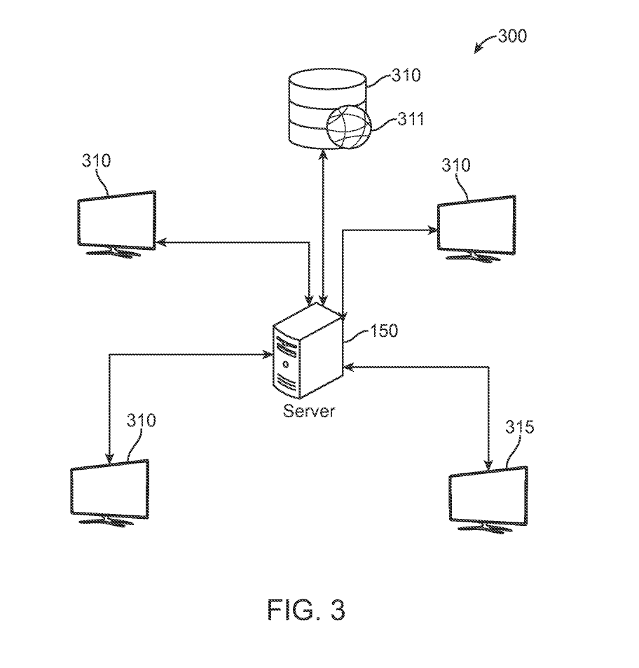

FIG. 3 shows an example distributed system 300 that may implement one or more embodiments. In one example, the distributed system 300 includes a server or service 150 and TV devices 310 and electronic device 315 (e.g., TV device 220, FIG. 2, computing device, portable device, monitor device, projector device, etc.), content provider 310 and Internet, cable or satellite connectivity 311. In one embodiment, in the distribution system 300, distributed TV devices 310 and 315 may send optical character recognition (OCR) results to the server or service 150, for channel banner template processing, as described below.

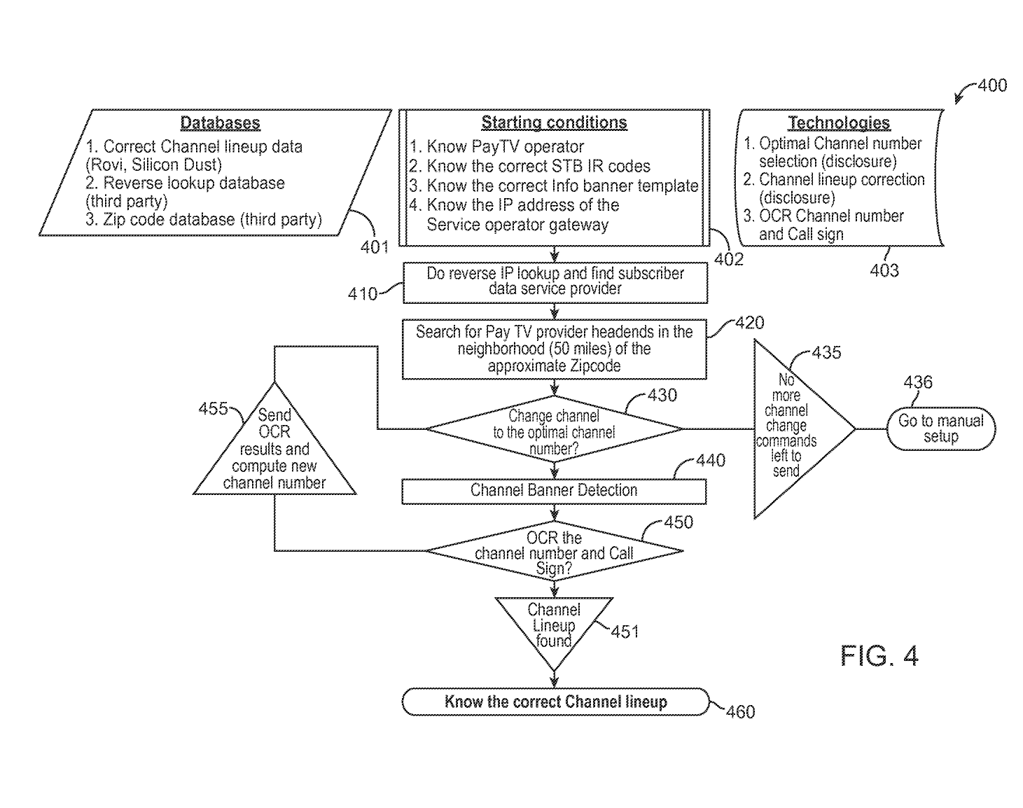

FIG. 4 shows a flow diagram 400 for automatically determining a correct MVPD or pay TV operator and IR codes, according to an embodiment. In one example, the appropriate IR remote command response is sent automatically, or may be used manually wherein a user responds to questions generated by one or more embodiments. Through the analysis of what is displayed on the TV screen, the embodiments remove the user (fully or partially) from the setup process. In one example, on screen display (OSD) detection, template matching, and OCR processes may be used to mimic what a user would see on an electronic device (e.g., TV device 220, FIG. 2) and how they would respond to generated questions.

In one example, the STB manufacturer and model type are needed to find the STB IR codes. The MVPD or Pay TV operator is needed for finding the correct channel map. In most cases, the user may be able and willing to enter the correct Pay TV operator. However, this information needs to be verified for accuracy. In one embodiment, detecting the presence of an OSD and then matching it with MVPD templates may be implemented for automatic determination of the MVPD that communicates with an STB. In one example, the following elements may be used for determining the correct or optimal STB IR codes or channel lineup.
1. Inputs—Ii: are inputs (e.g., key press or IR code) to the system;
2. Outputs—Oi: are observable outputs, such as channel change in response to an IR command, a Guide screen in response to the Guide (button) press/selection, etc. that the TV responds with when provided with an Input;
3. Transform—Ti: IR codes that defines how the input is converted to an output; and
4. Transform probability: Pi is the deployment probability of a particular transform. If the probability is not known, it is assumed that all transforms have the same probability; (where i is a positive integer).

In one embodiment, an input, given a transform, produces only one output; and this information is provided by the STB IR code database. In one embodiment, it is possible that for a given input, multiple transforms provide the same output: (1) discriminating output: given an input, if a unique output is produced from all transforms, then it is referred to as discriminating; (2) cost function for an input: Ci is the product of the probabilities of all discriminating outputs multiplied by the sum of the product for all non-discriminating outputs. For example, if outputs O1 and O3 are discriminating and O2 and O4 are not discriminating, then the cost function is P1*P3*(P2+P4).

In one embodiment, in block 401, databases (or other storage elements) include correct channel lineup data (e.g., Rovi, Silicon Dust, etc.), reverse lookup database (e.g., reverse IP from a third party, etc.), and a zip code database (e.g., third party, etc.). In block 402, example starting conditions may include the Pay TV (or MVPD) operators in the area are known, the correct STB IR codes for the local devices are known, correct channel banner templates for the local STBs/MVPDs are known, and the IP address for the service operator gateway are known.

In one example, in block 403, technologies used for process 400 include optimal channel number selection, channel lineup correction, and OCR for channel number and call sign. In one embodiment, in block 410, a reverse IP lookup is performed to attempt to find the subscriber data service provider. In block 420, a search is conducted for a Pay TV provider headends in the vicinity (e.g., 50 mile radius) for the local zip code.

In one embodiment, in block 430, it is determined if a change of channel on an STB (e.g., using an IR blaster commanded by the TV) changes a channel to an optimal channel number (e.g., an expected channel change). In one example, in block 435 if the channel change did not result in an optimal channel number, and no more channel change selections remain to be sent, process 400 continues to block 436. In block 436, the process 400 proceeds to a manual set up (e.g., querying a user for input).

In one embodiment, one the channel change is made in block 430, in block 440 detection of the channel banner is performed. In block 450, the process proceeds to perform OCR to detect the channel number on call sign for the channel banner (if detected). In one embodiment, in block 451 if the OCR in block 450 is successful, in block 455 the OCR results are sent (e.g., to a process or server for processing) and a new channel number is attempted to be detected. In one embodiment, once all the channel numbers and call signs are detected correctly, the process proceeds to block 451 where the channel lineup has been found and the process 400 exits at block 460.

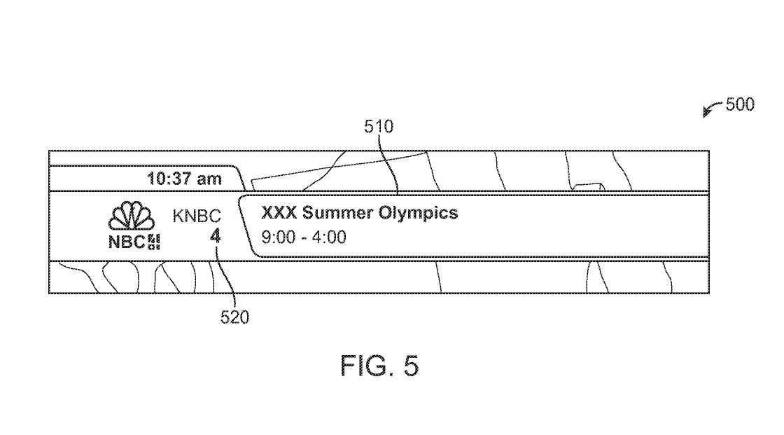

FIG. 5 shows an example MVPD channel banner 500. In one example, the title 510 and the channel number 520 (and call sign) are displayed on the channel banner. In one example, it is discernable if a TV connected to an STB is receiving a video signal (picture). In one embodiment, various types of screenshots are detectable, such as a blank screen, an un-subscribed screen indication, the “Info banner,” Guide banner, DVR and outputs from other key presses/commands, etc. In one embodiment, an STB IR key and channel banner template (Info banner, Guide, DVR etc.) are stored in advance in a database (e.g., either local or external in a server, cloud, etc.).

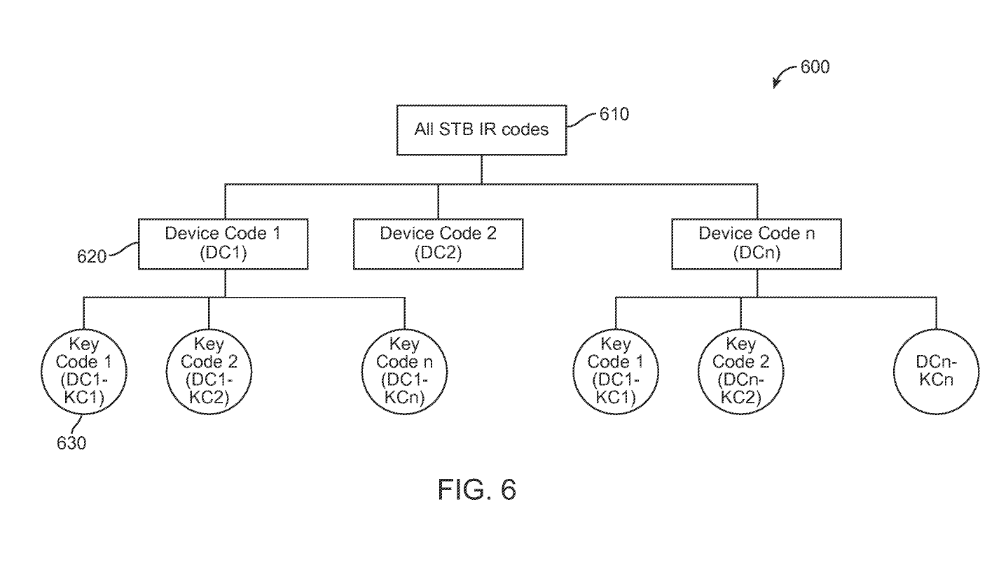

FIG. 6 shows a hierarchy 600 of device and key code sets for multiple STBs, according to an embodiment. In one example, the device codes 1-N 620 each are associated with key codes 1-N 630. In one example, STB IR codes have two parts, a manufacturer or “device code” 620 and the “key code” 630. In one embodiment, all IR commands sent from the IR blaster contain both these codes. For a STB, the combination of the device code and key code which is sent once a key is pressed is called “IR code” and the set of all IR codes for a STB is called “IR code set”. Each STB manufacturer has at least one manufacturer or device code, although there might be several. It is likely that multiple STB devices especially from the same manufacturer share the same “IR code set”. For a single device code, there might be more than one set of key codes. Here is information of interest: (a) a key code set may be a subset of another one. For example, a non DVR STB key code set may be a subset of that of a DVR STB. In this case, we do not distinguish between the two; we can just use the superset; (2) the key code for one or more keys in a set is different for different devices. For this case, the key code set are treated as different sets.

Some remote control keys when activated do not show an OSD (e.g., D-Pad keys), and therefore cannot be detected. The keys that may be detected with OSD are referred to as “detectable keys.” The detectable keys may include channel, volume, guide, DVR and power, all of which when selected (e.g., remote control press), show an OSD. In one example, only IR codes associated with the detectable keys are used as inputs. With each detectable key, one or more IR key code may be used by different STBs. The output for an IR key code is binary, since for an input (e.g., channel change IR key code) the output on a particular STB is either the channel change occurred or not.

In one example, an STB will have a set of IR codes for all of the detectable keys Kn. This set of key codes is represented as CSi, and it is the transform. It is possible that more than one STB model may share one code set. The total number of IR code sets would be less than or equal to the number of STBs. In one embodiment, it is assumed that the total number of STBs deployed that would connect to embodiment TVs is known (or may be intelligently guessed/determined). Based on this assumption, the probability that a particular STB to be connected to embodiment TVs may be determined. Since multiple STBs may share the same IR code set, the probability of an IR code set CSi is Pi. The sum of all probabilities is equal to 1. An example of this is shown in Table 1.

TABLE 1

| | IR code | IR code | IR code | IR code |
|---|---|---|---|---|
| | set 1: CS1 | set 2: CS2 | set 3: CS3 | set 4: CS4 |
| STB models | STB1 | STB2, | STB4 | STB5, STB6 |
| | | STB3, | | |
| Probability | P1 | P2 | P3 | P4 |

An example of inputs, output, transform and cost functions is presented in Table 2 below. The Input keys are Channel and Guide, which are assumed to be detectable. Associated with the channel key are three IR key codes, and with the Guide key there are two IR key codes: (1) the outputs may be success or failure indicated as Yes and No; (2) the output of at least one IR code for a particular key, would be successful (Yes) for each Code Set. For example, for code set CS2, the channel key IR code 3 results in success. The cost function is based on the probabilities as indicated in Table 1 above.

TABLE 2

| | Output | Output | Output | Output | |
|---|---|---|---|---|---|
| | of IR | of IR | of IR | of IR | |
| IR key codes for | code | code set | code set | code set | Cost |
| Detectable keys | set CS1 | CS2 | CS3 | CS4 | Function |
| Channel Key (IR | Yes | No | No | Yes | (P1 + P4) * |
| code 1) | | | | | (P2 + P3) |
| Channel Key (IR | Yes | No | No | No | P1 * (P2 + P3 + |
| code 2) | | | | | P4) |
| Channel Key (IR | No | Yes | Yes | Yes | P1 * (P2*P3 + |
| code 3) | | | | | P4) |
| Guide Key (IR | Yes | Yes | Yes | No | (P1 + P2 + P3) * |
| code 1) | | | | | P4 |
| Guide Key (IR | No | No | Yes | Yes | (P1 + P2) * |
| code 2) | | | | | (P3 + P4) |

In one embodiment, the process of STB IR code selection is as follows:
1. Assuming that the MVPD is already known, filter STBs based on their deployment by the MVPD.
2. Start with turning on-off the STB using the IR blaster controlled from the electronic device connected to the STB (e.g., TV device 220, FIG. 2). If the command works, the IR blaster is correctly placed. In one example, it is assumed that the on-off code for all STBs is the same; if different, the process cycles through all known codes. The STB “On” or “Off” may be found by checking for screen illumination (e.g., from OSD, OCR, luminance feedback, light detection, etc.
3. Compute the cost of each input from Table 2. The IR Key code with the least cost is sent by the IR blaster. The STB would either respond or not respond (Yes or No output) to this IR key code. The process removes the Code sets that conflict with the results of this input. For example, assume that the lowest cost function is for a Guide Key (IR code 2). In this case, send the Guide Key (IR key code 2) command to the STB and assume that the STB does not respond. In this example, the process removes IR code sets CS3 and CS4 from table 2 (it should be noted that the information in table 1 and 2 may be stored in a memory device on the electronic device connected to the STB).
4. Normalize the probability of the remaining Code Sets and compute the cost function for the remaining inputs. Send the input to the STB from the IR blaster corresponding to the lowest cost and once again remove the Code Sets that conflict with the results of this input. For example, assume that a new lowest cost function is associated with the Channel Key (IR code 1). The IR blaster sends the Channel Key (IR code 1) to the STB. In this example, assume that the STB responds to this IR command. Then remove the IR Code Set CS2.
5. Continue doing steps 3 and 4 until only one IR Key Code set remains, which is the correct IR Key Code Set. In this example, only one IR Key Code Set remains, and that is CS1, which is the correct IR Key Code Set.

In one embodiment, it is assumed that the number of STB models are deployed nationwide and per MVPD are known. This information is used to calculate the probability of the STB model when the electronic device is connected to the STB model. In one example, this may not be true since this type of information is generally not available. Reasonable determinations on the total number of STB deployed nationwide and per multi-system operator (MSO) may be made. If a reasonable determination cannot be made, in one example it is assumed that the STBs have equal probability. As consumers connect their STB, this information will be gathered and used to update the probability of finding an STB, which makes this methodology self-learning.

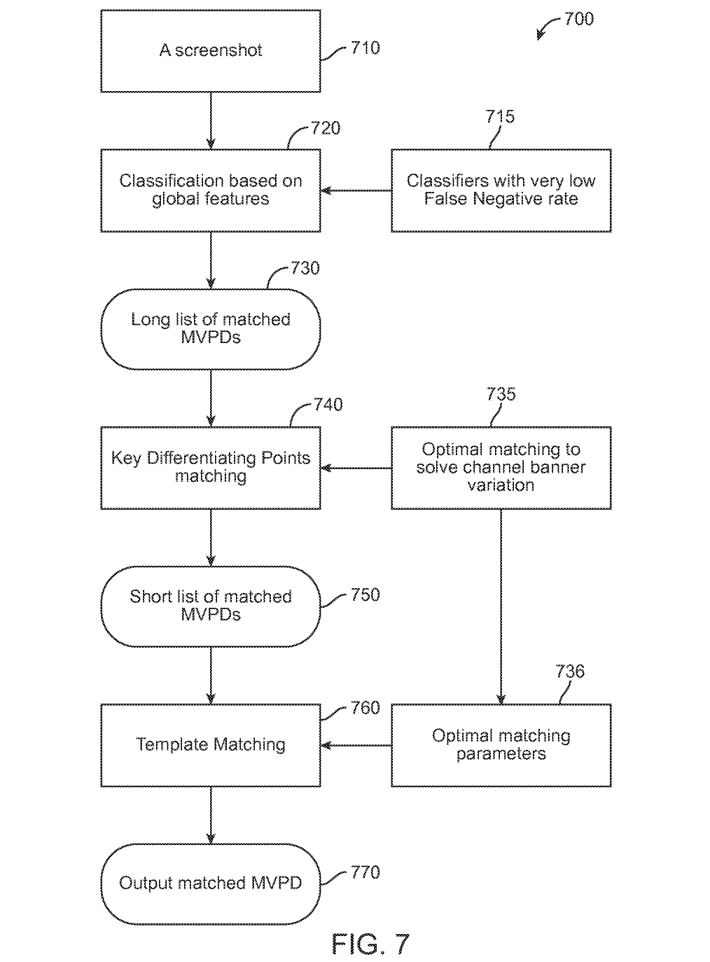

FIG. 7 shows a flow diagram 700 for automatic MPVD determination, according to an embodiment. In one embodiment, when the electronic device connected to an STB (e.g., TV device 220, FIG. 2) receives an IR code and responds, it is required to detect if the current screenshot contains a channel banner within a very limited time. Hence, a three-step process for channel change detection may be used to find the matched MVPD from a significantly large quantity of MVPDs. In one example, OCR may be performed based on the matched template to facilitate channel lineup selection. The channel banner detection and MVPD determination are described below.

In one example, it is assumed that a server or cloud service has a database of trained classifiers that are used to classify TV screenshots between screenshots with channel banners and those without channel banners. In Each classifier is built on the pre-collected channel banner images and non-banner images, which may be performed in an offline process. For the current screenshot, the classifiers may be employed to determine if there is possible channel banner. The MVPD of which the classifier outputs a positive result is placed in a possible matched MVPD list. With the classification step, a long list of MVPDs is produced. In one example, the server or cloud-based service has a database of all MVPD key points feature matrix. In one example, key points are defined for each MVPD to represent the channel banner. For the current screenshot, key points are extracted according to the definition of each MVPD and compared with stored key points of MVPDs from the previously produced long list. The matched MVPD is placed in the matched list. With the key point matching, a short list of MVPDs is produced.

In one embodiment, the server or cloud-based service has a database of all MVPD channel banner images present. From the short MVPD list, the exact matching may be conducted based on the channel banner templates to produce the final matched MVPD. In one embodiment, due to the potentially huge quantity of different channel banners from different MVPDs and STB models, an MVPD filtering process from coarse to fine may be employed.

In one embodiment, in block 710 a screenshot is displayed on an electronic device (e.g., TV device 220, FIG. 2). In block 720, classification is performed based on global features, where block 715 inputs classifiers with a low false negative rate. In block 730, a large/long list of matched MVPDs is received. In block 740, key differentiating points (KPD) that match are determined based on block 735 optimal matching for solving channel banner variation. In block 750, a short list of matched MVPDs is recorded. In block 736, optimal matching parameters (e.g., various channel banner coordinates and text placement) are used for block 760 performing template matching of channel banners. In block 770, the matched MVPD is output.

In one embodiment, when the screenshot from the optimal IR channel change is displayed (e.g., in block 710), the global image features are extracted. For each channel banner, a trained classifier between screenshots with a banner and without a banner is stored in the database, and applied on the current global feature. If a classifier outputs a positive label, the corresponding channel banner is a potentially matched channel banner, and the corresponding MVPD is included in the possible matched MVPD list. Considering a similar channel banner, the global feature based classification may produce some false-positive results. Hence, this coarse filtering process generates a long possibly matched MVPD list, which narrows down the further matching range. The local image feature is extracted from the screenshot, and compared with the corresponding stored feature. During the comparison, the similarity measure is calculated, and then compared with the pre-defined threshold. In one example, if the similarity is smaller than the threshold, the channel banner of the stored feature may be a potential matched channel banner, and the corresponding MVPD is output to the matched list. With this process 700, the matched MVPD list is further narrowed down. The feature matching may employ some strategy to solve the channel banner variation, such as shifting and stretching. In one embodiment, a pixel-by-pixel template matching process is used to find the exact matched MVPD, according to the variation parameters from last step. It should be noted that in one or more embodiments, the blocks in process 700 may change in order, or skip one or more steps to achieve the optimal results.

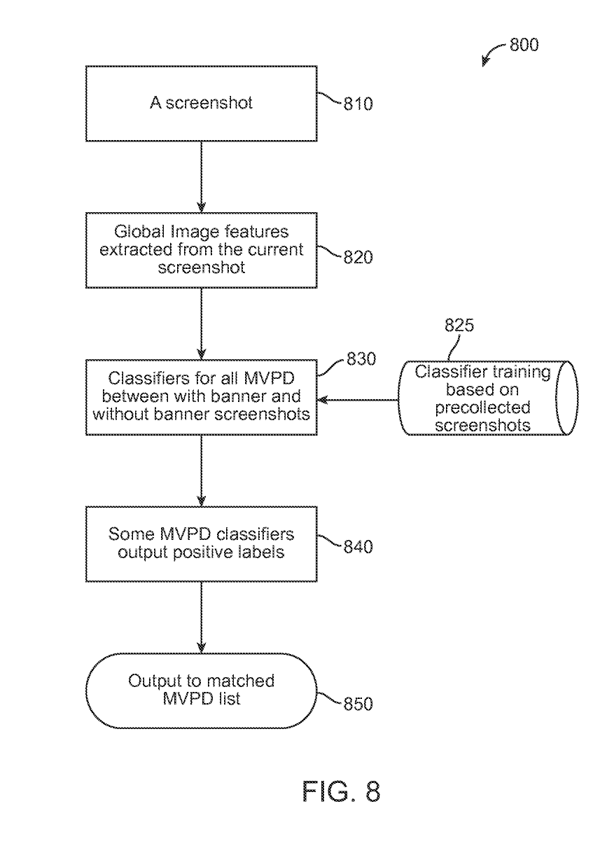

FIG. 8 shows a flow diagram 800 for classifying of MPVDs, according to an embodiment. In one embodiment, the classification based on global features is a coarse procedure to generate a long list of possibly matched MVPDs. In one example, any global feature that may discriminate channel banner screenshots from non-banner screenshots may be used. Further, any binary classification may be employed. In one example, the global feature may include a global color moment, shape, logo, etc. In one example, in block 810 a screenshot results from a channel change command from the IR blaster. In block 820, global features are extracted from the current screenshot (e.g., using OSD, OCR, etc.). In one example, in block 825, classifier training based on collected screenshots are obtained for comparison in block 830 between classifiers for all MVPD with a banner and without banner screenshots.

In one example, in block 840 at least some of the MVPD classifiers output positive labels. In block 850, the MVPDs that output positive labels are placed in the matched MVPD list and stored for future processing.

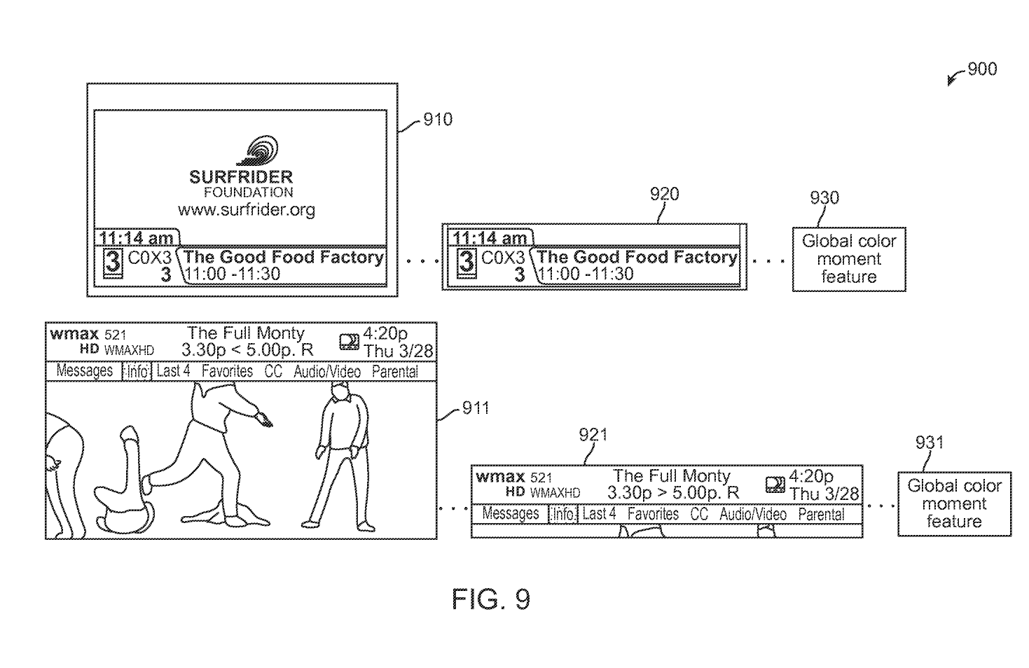

FIG. 9 shows examples of screenshots 910 and 911, associated banners 920 and 921 and extraction of a global feature 930 and 931, according to an embodiment. In one embodiment, the channel banner may usually be located on the top or bottom of the screenshot, and less than one-third part of the entire screen. Therefore, in one embodiment, either the top or bottom one third part of the screen is cropped from the screenshot. Then the color moment is extracted from the cropped sub-images.

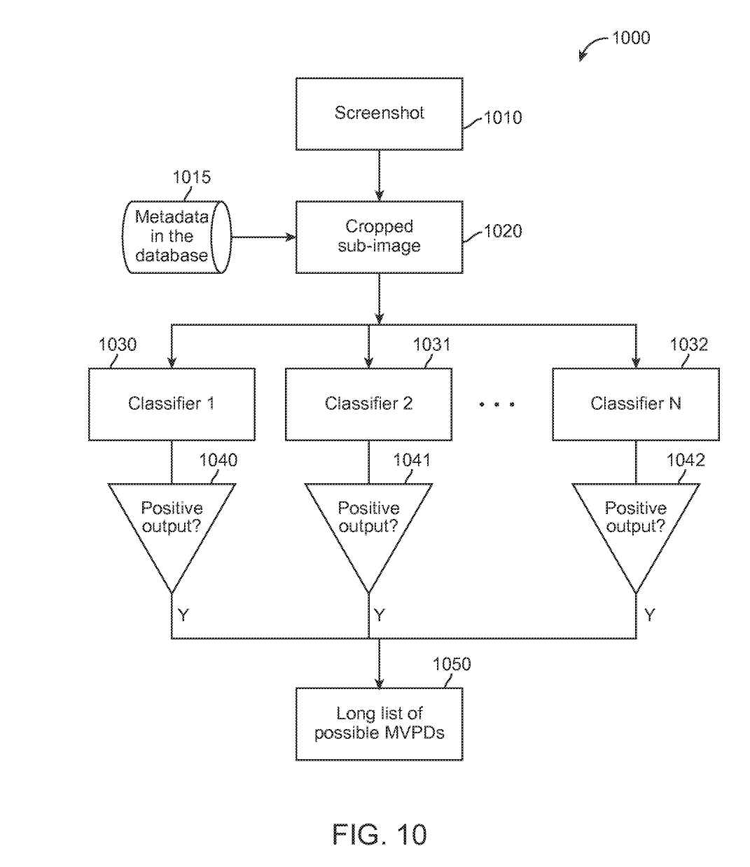

FIG. 10 shows a flow diagram 1000 for binary classification of MPVDs, according to an embodiment. In one embodiment, support vector machine (SVM) classification between screenshots with a channel banner and without a channel banner is employed. The SVM classification is a binary classifier that requires training based on labeled positive and negative data. In one example, for each MVPD, a classifier is built for screenshots with a channel banner and without a channel banner. In one embodiment, in the training, several screenshots are collected, both with a channel banner and without a channel banner. For the screenshots with a channel banner, the one third portion containing the channel banner is cropped, which produces the positive data. For the screenshots without a channel banner, the one third portion at the same location and same size is cropped, which produces the negative data. At the same time, the location information is also stored in the database as metadata. Then the SVM classifier corresponding to the MVPD may be learned. In one embodiment, for different MVPDs, the classifiers are independently trained. In one example, the classifier training may be performed offline.

In one example, for the current screenshot, the sub-image is cropped according to the metadata, and then the extracted global feature is input to every binary classifier. For those classifiers whose output is positive, the current screenshot may contain the corresponding channel banner. Therefore, the MVPD name is output to the list.

In one embodiment, in block 1010 the screenshot from an IR blaster command is displayed on the electronic device (e.g., TV device 220, FIG. 2) connected to the STB. In one example, in block 1015, metadata in the database is obtained for use in block 1020, where the screenshot is cropped producing a cropped sub-image. In one embodiment, in blocks 1030, and 1031 through 1032 classifiers are determined. In one embodiment, in blocks 1040 and 1041 through 1042 it is determined if the output is a positive label. In one example, in block 1050 if the output from any of the blocks 1040, and 1041 through 1042 are positive, the result is added to the long list of possible MVPDs.

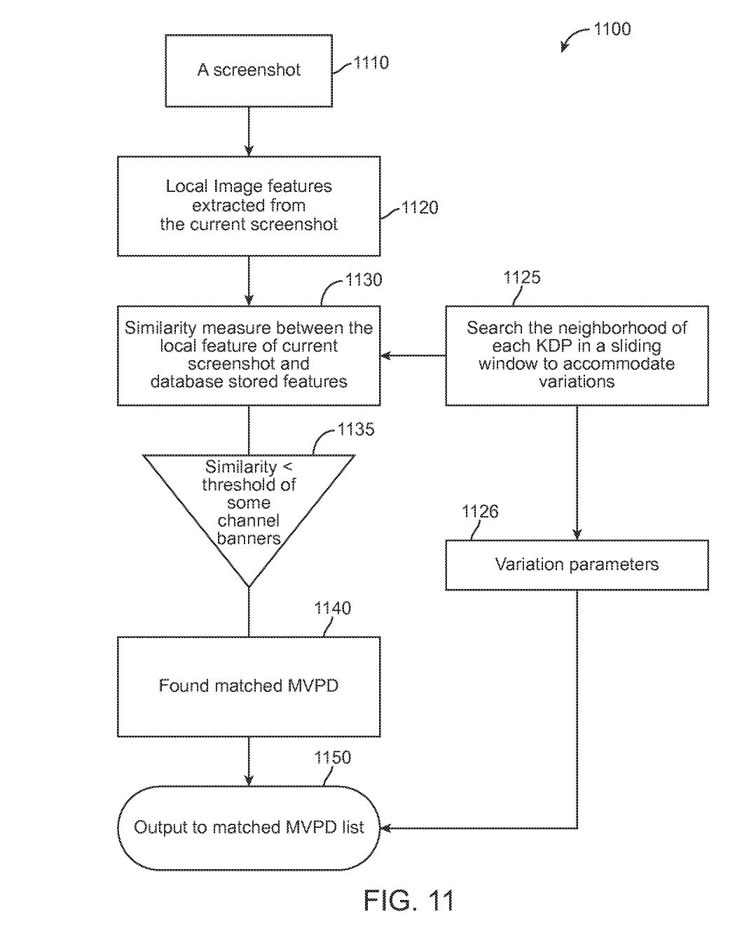

FIG. 11 shows a flow diagram 1100 for local classification of MPVDs, according to an embodiment. In one embodiment, from the long MVPD list, a finer matching process based on local features is implemented. KDPs are implemented as the local feature. KDPs of all the possible MVPDs are stored in the database (e.g., in a server or cloud-based service) as a matrix. In one example, as the electronic device requests, a partial KDP matrix is formed and downloaded by the electronic device. For the current screenshot, the KDPs are extracted and compared with the downloaded KDP matrix. Based on the pre-defined similarity measure, the similar KDPs are determined, and the corresponding MVPD is selected as one of the possible matched MVPDs.

In one example, in block 1110 a screenshot is displayed based on the IR blaster command to change/select a channel. In block 1120 local image features are extracted from the current screenshot. In block 1125, the neighborhood of each KDP is searched in a sliding window to accommodate variations, and the results are input to block 1130 for measuring similarity between the local features of the current screenshot and features stored in a database (e.g., connected with a server or cloud-based service, etc.), and the outputs of variation parameters in block 1126 are input to the matched MVPD list.

In one example, in block 1135 if the similarity measurement results are less than a threshold of some channel banners, then in block 1140 the MVPD is considered to be found as a match. The MVPD is then output to the MVPD list in block 1150.

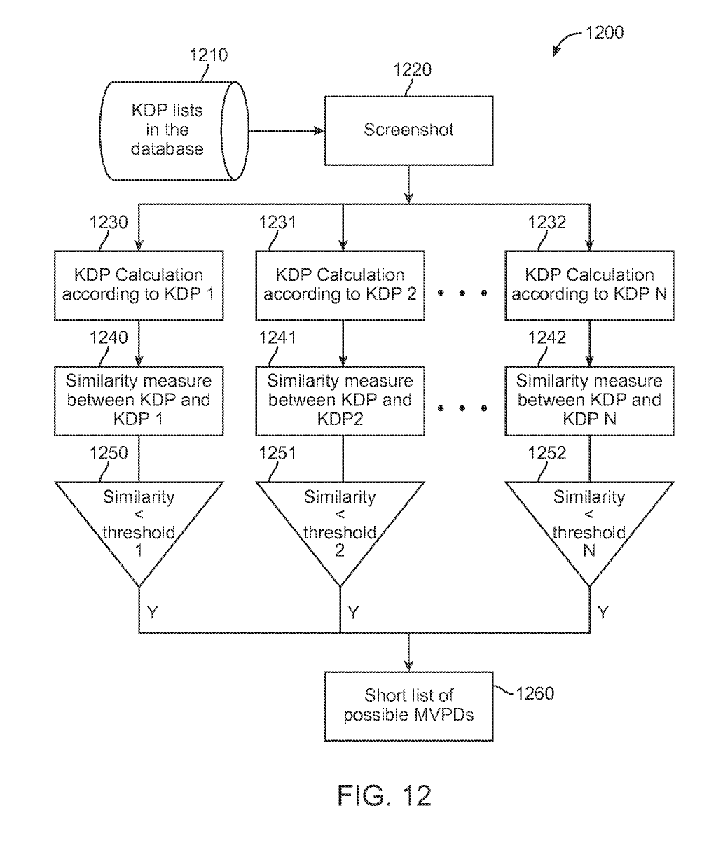

FIG. 12 shows a flow diagram 1200 for KDP matching, according to an embodiment. In one embodiment, the flow diagram includes KDP lists in the database 1210, a screenshot 1220, KDP calculations according to KDPs1-N (1230, 1231, to 1232), similarity measure between KDP and KDPs1-N (1240, 1241 to 1242), determination of similarity as compared to a threshold 1250, 1251-1252 and th short list of possible MVPDs 1260. Since the KDPs of different channel banners are different, the KDP of the current screenshot should be extracted according to the definition of each MVPD, and compared with different KDPs of each MVPD. In one example, for a specific MVPD, if the similarity is smaller than the threshold, the MVPD is considered as a possibly matched MVPD and output to the matched list. At the same time, considering the variation of the same channel banner due to shifting, stretch, and different resolution, the KDP matching employs a sliding search strategy to find the optimal matched KDP. In one embodiment, through the sliding search, the channel banner variation may be detected, which is used as the variation parameters for the final banner template matching. From the KDP matching, a many unmatched MVPDs are removed from the long MVPD list, so that a shorter matched MVPD list is generated.

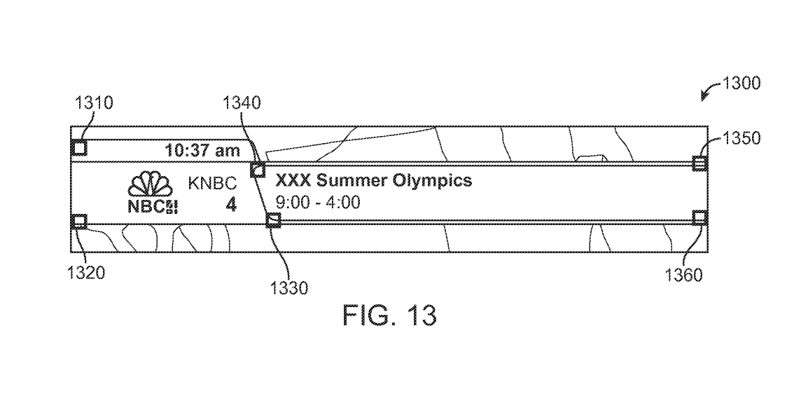

FIG. 13 shows an example channel banner 1300 with KDPs (1310, 1320, 1330, 1340, 1350 and 1360) shown as marked, according to an embodiment. In one embodiment, KDPs are coordinates on a banner template that never change. In one example, it is recognized that a majority of channel banners have transparency. In this case the channel banner as a whole would change from frame to frame based on the video that bleeds through. In one embodiment, KDPs make sure that the coordinates selected are opaque and remain constant between multiple instances of a channel banner. In one example, selection of the KDPs may be performed manually or by using processes, such as scale-invariant feature transforms.

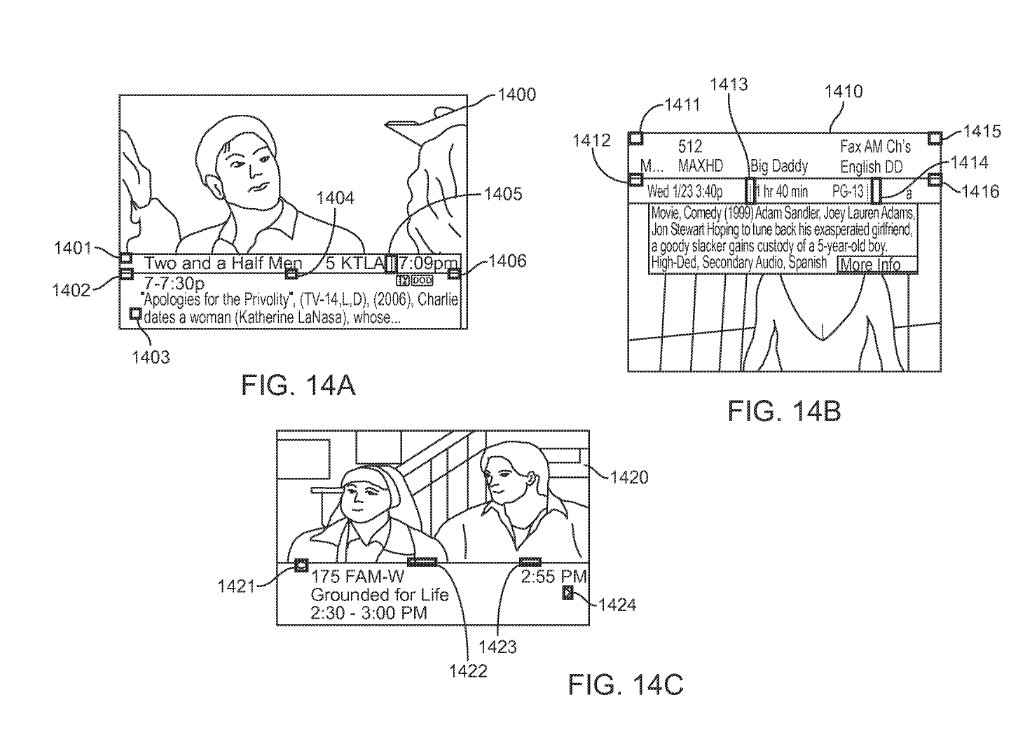

FIGS. 14A-C show examples of screenshots 1400, 1410 and 1420 with KDPs marked on banner portions, according to an embodiment. In screenshot example 1400, KDPs 1401, 1402, 1403, 1404, 1405 and 1406 are marked by square/rectangle marks. In screenshot example 1410, KDPs 1411, 1412, 1413, 1414, 1415 and 1416 are marked by square/rectangle marks. In screenshot example 1420, KDPs 1421, 1422, 1423 and 1424 are marked by square/rectangle marks. In one example, the KDP points are selected based on the opacity and their consistency among various instances of the channel banner. For example, in the channel banner 1300 (FIG. 13), the edges are opaque and would therefore qualify to be part of the KDPs.

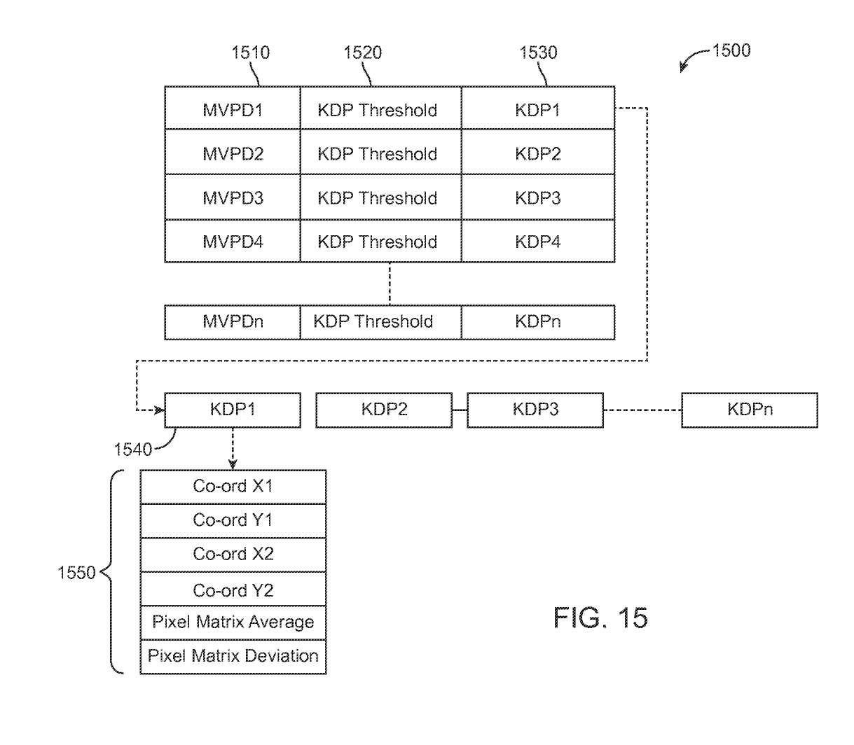

FIG. 15 shows an example key value pair vector 1500, according to an embodiment. In one example, once the KDP for each channel have been identified, upon request from the electronic device (e.g., TV device 220, FIG. 2) connected to the STB, these KDP's 1530 are laid down in the form of a vector and sent to the electronic device. In one embodiment, the vector 1500 includes key value pairs. In one example, the key represents a unique ID 1510 associated with the MVPD the channel banner belongs to. The value represents a KDP threshold 1520 and a pointer 1530 to the KDP 1540 Linked list 1550. Following is an example of the vector representation:

<Unique MVPD ID, {KDP Threshold, Pointer to KDP List}> Each of these values will be defined below:

Unique MVPD ID 1510: The Unique MVPD ID, uniquely identifies the MVPD and other information in the server or cloud-based service, such as the STB's this channel banner shows up on, all the associated zip codes this channel banner shows up in, etc.

KDP Threshold 1520: The final value calculated from the comparison of all the points in a KDP are verified against this threshold value to determine if that particular MVPD channel banner is present on the TV screen or not.

Pointer 1530 to KDP 1540 List 1550: The ‘Pointer to KDP List’ is a pointer to a linked list of key differentiating points. Each key differentiating point (in the linked list) is a structure that contains the following values:
Co-ordinates of the Pixel Matrix to be matched (X1, Y1 and X2, Y2)
Pixel Matrix Average
Pixel Matrix Deviation.

In one embodiment, the idea is to crop the Pixel matrix from the screen buffer captured on the electronic device display and match it against the pixel matrix average and deviation values to determine if a point matched or not. In one example, all the comparison values are combined to form a final value.

In one embodiment, the following are the basic steps for forming the final value:
(1) The electronic device (e.g., TV device 220, FIG. 2) starts up and performs a reverse IP lookup to determine the approximate location (zip code) and the data provider for the TV device.
(2) The resulting information from (1) is sent to the server or cloud-based service.
(3) At this point the process may not be certain if the TV subscriber has subscribed to TV and data services from the same MVPD. Therefore, in one example probabilistic and machine learning techniques are applied to determine the MVPDs that might provide the subscriber TV service. For example, if the subscriber subscribes to a company A for data services, it is highly probable they might subscribe to Company B or Company C for TV Pay service (e.g., satellite, cable, etc.).
(4) The server or cloud-based service then gathers all the templates corresponding to these MVPDs and Zip Code from the Template server database.
(5) The server or cloud-based service then creates a matrix of KDPs from the list of templates in the database.
(6) The KDP vector is downloaded by the TV device.
(7) A TV module (e.g., access module 1020, FIG. 2) loops based on a predefined time and performs screen capture.
(8) The screen capture is used to compare against the matrix values of KDPs from all templates.
(9) If a match is found it can safely be assumed that a channel banner exists on the TV screen. This screen capture is then sent to the server or cloud-based service.

The KDP calculation and similarity measure is described as follows. In one embodiment, in the KDP 1540 Linked List 1550, the feature values are stored. In one example, any image feature may be used in the KDP 1540, especially one or more color features, such as color moment. In one example, the KDP calculation and similarity measure is described with the color moment feature. For each KDP 1540, the color moments are extracted and used as the features. Color moments provide a measurement for color similarity between images. The first two central moments of an image's color distribution are mean and standard deviation, defined as follows below.

In one example, the color moments are restricted to the RGB color scheme of Red, Green, and Blue. Moments are calculated for each of these color channels in a KDP 1540. In one example, each KDP 1540 is characterized by 6 moments. It is defined that the pixel value of the i-th color channel and the j-th pixel as pᵢⱼ (i and j being positive integers). Moment 1—Mean: Mean is the average pixel color value in the KDP.

$${E}_{i} = {\sum }_{j = 1}^{N} \frac{1}{N} {p}_{ij}$$

Moment 2—Standard Deviation: The standard deviation is the square root of the variance of the distribution:

$${σ}_{i = \sqrt{( \frac{1}{N} {\sum }_{j = 1}^{N} {( {p}_{ij} - {E}_{i} )}^{2} )}} .$$

So for each KDP 1540, we have a 6-dimensional feature vector as

$$( \begin{matrix}{E}_{1} \\ {σ}_{1} \\ {E}_{2} \\ {σ}_{2} \\ {E}_{3} \\ {σ}_{3}\end{matrix} ) .$$

And all the KDPs in a channel banner composite a feature matrix which will be stored in the KDP 1540 Linked List 1550. Suppose there are K KDPs 1540 in a channel banner, in one example the feature matrix is represented as:

$${f}_{KDP} = ( \begin{matrix}{E}_{11} & … & {E}_{1 K} \\ {σ}_{11} & … & {σ}_{1 K} \\ {E}_{21} & … & {E}_{2 K} \\ {σ}_{21} & … & {σ}_{2 K} \\ {E}_{31} & … & {E}_{3 K} \\ {σ}_{31} & … & {σ}_{3 K}\end{matrix} ) .$$

Based on the KDP feature matrix, the banner template may be detected by the KDP similarity between stored MVPD KDPs and the extracted KDP from the current screen captured image. In one example, on the current screen captured image, the KDPs 1540 are located by the coordinates information by each MVPD. And the feature matrix is calculated. In one example, suppose there are M MVPD, so there will be M feature matrix candidates, {f_{KDP}_{₁}, f_{KDP}_{₂}, . . . , f_{KDPM}}. Then the similarity is measured between the stored MVPD KDP and the corresponding extracted KDP candidate. If the Euclidean distance is used, the similarity is:

d_{KDP1}={square root over (Σᵢ₌₁³Σⱼ₌₁^{K}(α(Eᵢⱼ^{T}−Eᵢⱼ^{I})²+β(σᵢⱼ^{T}−σᵢⱼ^{I})²))},

in which T denotes the values from the MVPD templates, and I denotes the values from the current screen image. Among all the distance similarity, {d f_{KDP}_{₁}, d f_{KDP}_{₂}, . . . , d f_{KDPM}}, the KDP with the minimum distance value is considered as the possible match. In one embodiment, it may be asserted that the current channel is from this MVPD. Further, the distance value is compared with the stored KDP threshold 1520. If the value is less than the threshold, the channel banner is detected in the current screen image; and vice versa.

$$detection\_result = \{ \begin{matrix}1 & {d}_{KDP\_min} < threshold \\ 0 & {d}_{KDP\_min} > threshold\end{matrix}$$

In which, 1 means a channel banner exists, and 0 means the channel banner does not exist.

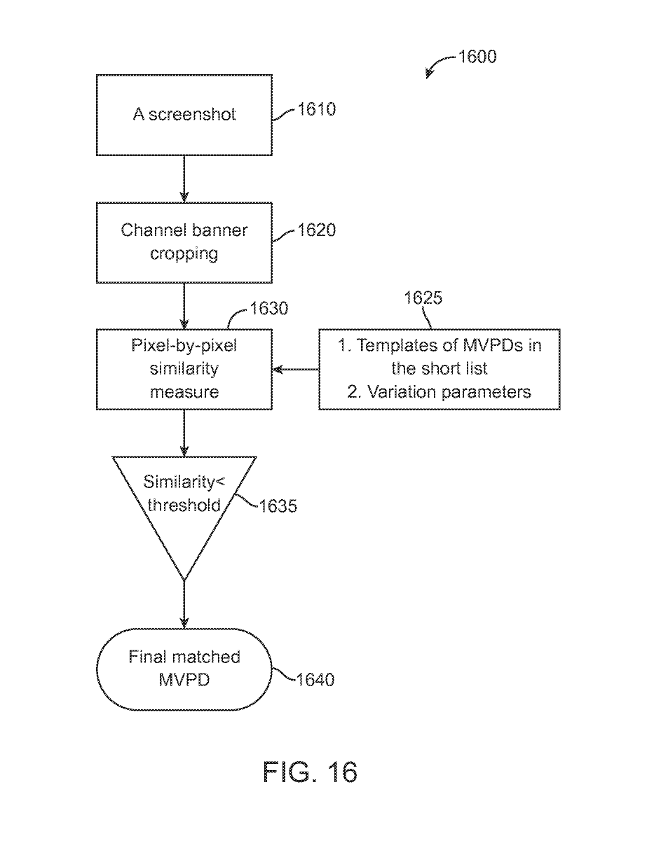

FIG. 16 shows a flow diagram 1600 for template matching, according to an embodiment. In one embodiment, the last step is to verify the Pay TV (or MVPD) operator and to find a GUI template that will then be used to select the correct channel lineup. The GUI template of interest is the “Info banner” which is used to select the correct channel lineup. Larger MVPDs have one or more GUI templates that work across several STBs that they deploy. However, smaller MVPDs might share the same GUI templates. As the finest step, the pixel-by-pixel matching is conducted between the screenshot and the banner templates of the MVPD list. Some variation parameters from the previous step are used. After banner template matching, the final matched MVPD is determined. Further, OCR may be performed on the channel banner to obtain the channel information.

In one embodiment, in block 1610 the current screenshot is displayed by the electronic device (e.g., TV 220, FIG. 2). In block 1620, channel banner cropping is performed. In block 1625, the templates of the MVPDs in the short list and the variation parameters are used by block 1630 for performing a pixel-by-pixel measurement. In one example, in block 1635, it is determined if the similarity determined in block 1630 is less than a threshold. If the similarity is less than the threshold, then in block 1640 the final matched MVPD is determined.

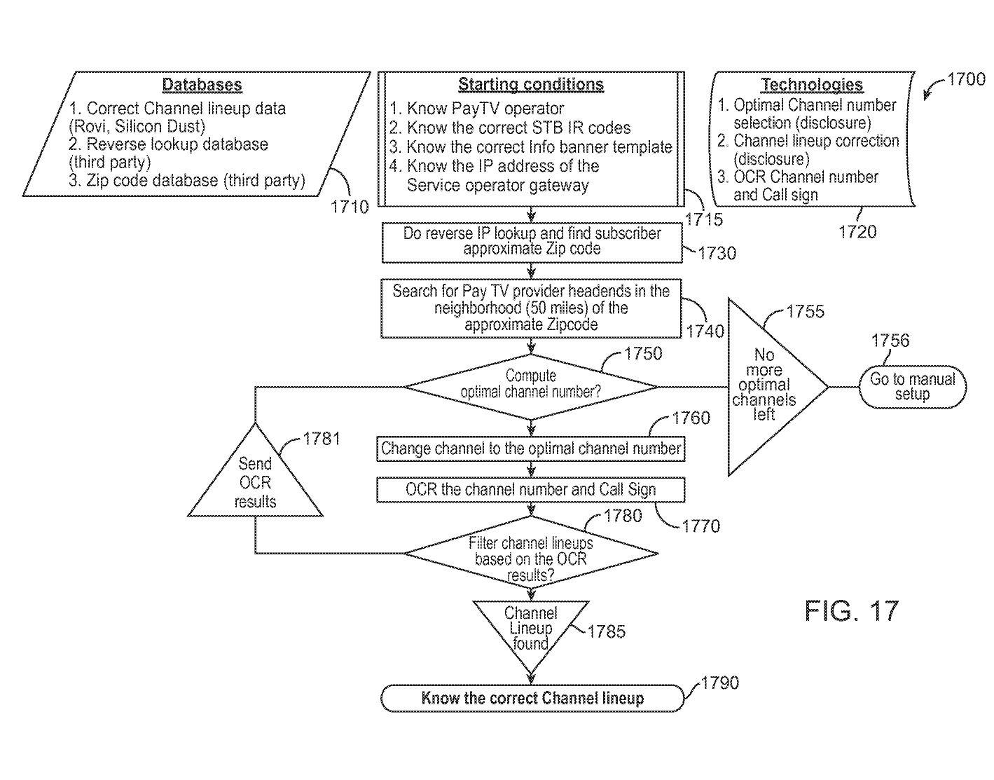

FIG. 17 shows a flow diagram 1700 for automatically determining a correct pay TV operator and channel lineup, according to an embodiment. In one embodiment, process 1700 optimally selects the MVPD channel lineup. By using process 1700, a TV 220 (FIG. 2) automatically sends a response to the appropriate IR remote command, or by sending IR channel change commands, a user responds to questions generated by the process 1700. In one example, by analyzing the TV 220 screen display, a user is removed (fully or partially) from the setup process. The OSD detection, banner template matching, and OCR processing may be used to mimic what the user would see on the TV display and how they would respond to the questions.

During a setup procedure, the user is requested to place an IR blaster (e.g., a small dongle attached to a wire) next to their STB and to provide the following information to correctly receive the channel lineup and EPG:
1. Zip code and Pay TV operator or MVPD,
2. Select from one of the channel lineups if multiple matching lineups are present.

The user, however, may not know the correct information, enters the wrong information, or simply fails to enter the information. In one embodiment, the process 1700 finds the approximate subscriber Zip code and potential lineups, and then uses optimal channel selection processes to filter out the wrong lineups. Additionally, process 1700 automatically detects the channel name using OCR, and uses this information as a feedback to the optimal channel selection processes.

In one embodiment, in block 1710, databases (or other storage elements) include correct channel lineup data (e.g., Rovi, Silicon Dust, etc.), reverse lookup database (e.g., reverse IP/Zip Code from a third party, etc.), and a zip code database (e.g., third party, etc.). In block 1715, example starting conditions may include the Pay TV (or MVPD) operators in the area are known, the correct STB IR codes for the local devices are known, correct channel banner templates for the local STBs/MVPDs are known, and the IP address for the service operator gateway are known.

In one example, in block 1720, technologies used for process 1700 include optimal channel number selection, channel lineup correction, and OCR for channel number and call sign. In one embodiment, in block 1730, a reverse IP lookup is performed to attempt to find the subscriber data service provider. In block 1740, a search is conducted for a Pay TV provider headends in the vicinity (e.g., 50 mile radius) for the local zip code.

In block 1750, it is determined if the optimal channel number is computed yet. In one example, if the optimal channel number is not computed yet, and in block 1755 it is determined that there are no more optimal channels left to compute, process 1700 continues to block 1756 where a manual set up (e.g., querying a user for input) is proceeded with. In one embodiment, in block 1760, it is determined if a change of channel on an STB (e.g., using an IR blaster commanded by the TV 220, FIG. 2) changes a channel to an optimal channel number (e.g., an expected channel change).

In one embodiment, once the channel change is made in block 1760, in block 1770, the process proceeds to perform OCR to detect the channel number on call sign for the channel banner (if detected). In one embodiment, in block 1780 the channel lineups are filtered based on the OCR results in block 1770. In block 1781 the OCR results are sent (e.g., to a process or server for processing) and a new channel number is attempted to be detected. In one embodiment, once all the channel numbers and call signs are detected correctly, the process proceeds to block 1785 where the channel lineup has been found and the process 1700 exits at block 1790 with the results of the correct channel lineup being determined.

In one example, the STB type, the pay TV operator, and STB “Info banner” template are known elements. This information allows an OCR process to determine the correct channel number and call sign during a channel change. In one example, it is assumed that the channel map (e.g., Rovi) is correct, and that all customers have access to at least the basic and local channels (e.g., ABC, CBS etc.). In one example, the reverse IP lookup is performed and process 1700 finds the Zip code of the IP service operator gateway. Since this information is not accurate, some number (e.g., 50 or 100, etc.) nearest Zip codes from the Zip code database is determined. This provides the list of all channel lineups that service these Zip codes for the particular Pay TV operator.

In one embodiment, it is also possible to obtain the Zip code from the user and this may be less error prone than other information. In one example, if user provides this information, it may be used to validate the information found from reverse IP lookup and reduces the list of potential matching headends.

In one example, if the process 1700 tunes to a particular channel number and the result is not the same on all channel lineups, then it is a discriminating feature. A discriminating channel classifies the lineups into multiple groups according to the different call signs. For example in table 3, channel 3 classifies the three lineups into two groups, the first group (with call sign ABC) includes line up 1 and 2, and the second group (Null) includes line up 3. The discriminating features are then: Channels that exist in one or more Channel Lineup but not in others. An example of this is presented below.

TABLE 3

| Channel Lineup 1 | | Channel Lineup 2 | | Lineup 3 | |
|---|---|---|---|---|---|
| Channel | | Channel | | Channel | |
| No | Call Sign | No | Call Sign | No | Call Sign |
| 3 | ABC | 3 | ABC | 3 | Null |
| 5 | CNN | 5 | NULL | 5 | Null |

In one example, all Channels exist, but one or more have different call signs. An example of this type of discriminating feature is presented in table 4.

TABLE 4

| Channel Lineup 1 | | Channel Lineup 2 | | Channel Lineup 3 | |
|---|---|---|---|---|---|
| Channel | | Channel | | Channel | |
| No | Call Sign | No | Call Sign | No | Call Sign |
| 3 | ABC | 3 | NBC | 3 | CBS |
| 5 | ESPN | 5 | ESPN | 5 | CNN |

In one example, if the process tunes to a channel number and the result is the same for all channel lineups, then it a non-discriminating feature. Examples of non-discriminating features are:
1. A channel number is missing from all lineups.
2. A channel number has the same call sign for all channel lineups

In one embodiment, the probability of finding a particular channel lineup in the filtered domain is implemented. In general, it is the probability of finding channel lineups of a Pay TV operator in a Zip code. Table 5 below has four channel lineups each with its own probability. In case, the probabilities of various lineups are unknown, the market share of a Pay TV operator may be used instead, or it may be assumed that all probabilities are the same. In one example, the sum of all probabilities for potential lineups adds up to one.

TABLE 5

| | Channel | Channel | Channel | Channel |
|---|---|---|---|---|
| | Lineup CL1 | Lineup CL2 | Lineup CL3 | Lineup CL4 |
| Probability | P1 | P2 | P3 | P4 |

In one embodiment, a cost function for each channel is a measure of how much information it may provide (or how discriminating the channel is). In general, the more discriminating the channel is, the smaller cost it has. In this case, the most discriminating channel is the one with smallest cost. Tuning to a discriminating channel results in more than one output and group channel lineups that have the same output. The probability of finding a group is the sum of probabilities of all lineups in this group. The cost function of the channel is the product of probabilities of all these groups. Table 6 below is an example of four channel lineups CL1, CL2, CL3, and CL4, along with the cost function of tuning to a particular channel number. For example in table 6, channel 5 classifies the four lineups into two groups; group one includes CL1 and CL2, group 2 includes CL3 and CL4. The probability of group one is P1+P2 and the probability for group 2 is P3+P4. The cost of channel 5 is (P1+P2)*(P3+P4).

TABLE 6

| | Channel | Channel | Channel | Channel | |
|---|---|---|---|---|---|
| Channel | Lineup | Lineup | Lineup | Lineup | Cost |
| Numbers | CL1 | CL2 | CL3 | CL4 | function |
| 3 | ABC | NBC | CBS | CBS | P1*P2* (P3 + |
| | | | | | P4) |
| 5 | CBS | CBS | ESPN1 | ESPN2 | (P1 + P2) * |
| | | | | | (P3 + P4) |
| 6 | ESPN2 | ESPN2 | ESPN2 | NULL | (P1 + P2 + P3) * |
| | | | | | P4 |
| 9 | HIS | ESPN1 | HIS | HIS | (P1 + P3 + P4) * |
| | | | | | P3 |
| 11 | FOX | DIS | FOX | ABC | (P1 + P3) *P3* |
| | | | | | P4 |
| 13 | ESPN1 | NULL | NULL | NULL | P1* (P2 + P3 + |
| | | | | | P4) |

In one embodiment, for determining the correct STB, all the non-discriminating channels are removed from the applicable channel lineups. The cost function is computed for all the discriminating channels and the IR blaster tunes to the channel number with the lowest cost function. For example, in Table 6, assume that the lowest cost is for Channel 11, then the IR blaster is commanded by the TV device 220 (FIG. 2) to tune to channel 11. Based on the result of this channel tune operation, the channel Lineups that conflict with the result are removed from the table or list. For example, if tuning to channel 11 shows FOX®, then the process removes Channel Lineups CL2 and CL4 that show DIS and ABC®.

In one example, the probability of the remaining Channel Lineups is normalized and the cost function is recomputed. In one embodiment, the tune command for the lowest cost channel is sent by the IR blaster. For example, the lowest cost is for Channel number 3, and then the IR blaster is commanded to tune to channel 3. The process repeats the removing and normalizing operations until the only one channel lineup remains. The last remaining channel lineup is the correct channel lineup. For example, if tuning to channel 3 shows ABC, then the channel lineup is CL1.

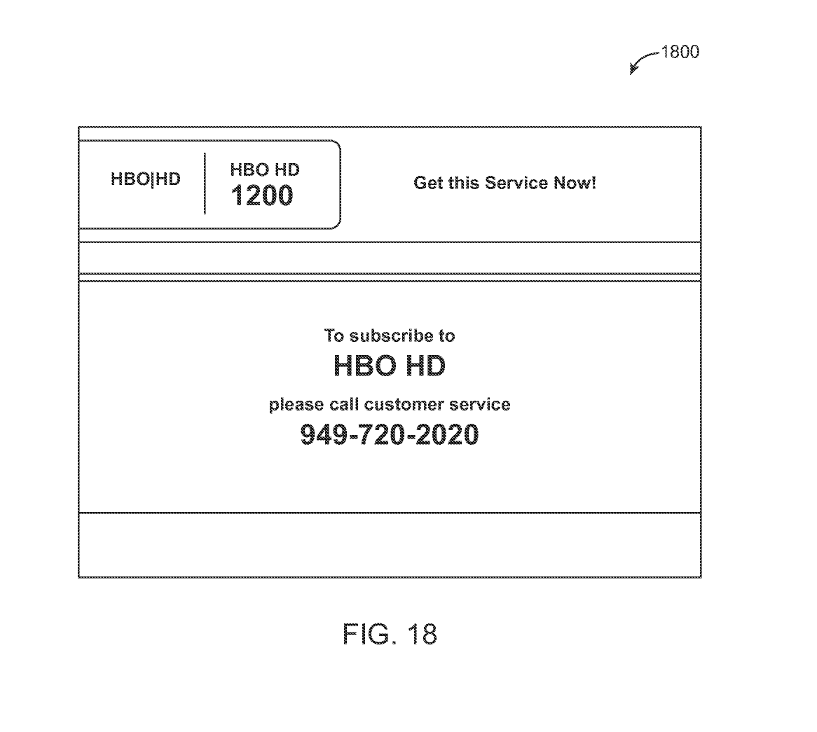

FIG. 18 shows an example screenshot 1800 of an unsubscribed channel. A user subscription tier may not be known in advance. This information is useful for:
1. Better user experience: automatically creating a lineup of subscribed channels only.
2. For advertisement purposes: partnering with content owners and up selling only the unsubscribed channels.

When the user tunes to a channel that they have not subscribed to, the STB typically shows a message reading something like “To subscribe this channel, please call your operator at 1-8xx-xxx-xxxx.” as shown in example 1800. In one embodiment, if a template is created for the unsubscribed message, it may be matched when displayed on the TV device 220 (FIG. 2). The template matching process is described below. In one embodiment, the subscription package detection algorithm is run either:
1. At startup after a proprietary application on the TV device 220, channel selection.
2. During normal operation when a user tunes to a channel the first time.

Typically, MVPDs offer channels as a package. Assuming that the channel package is known, only one channel from a package is required to be tuned to for determining if the user has subscribed to this package.

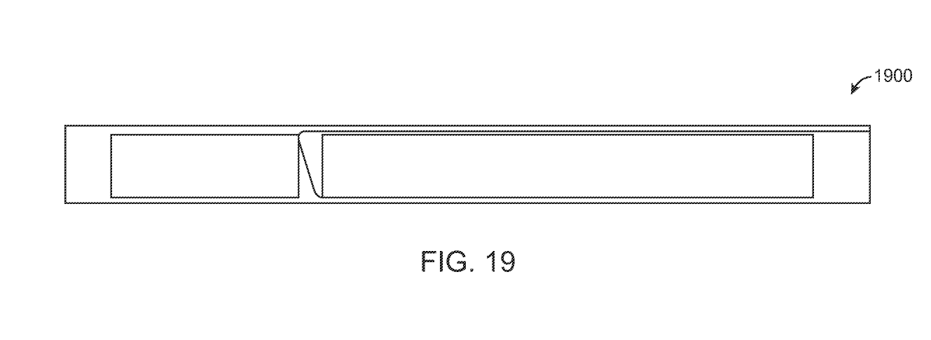

FIG. 19 shows an example template 1900 for a channel banner, according to an embodiment. Whenever a user changes a channel on the STB, an overlay image is displayed on the TV Frame buffer. The channel banner displays important information, such as channel number, call sign, channel description etc. The channel banner remains on the screen for a specific/configurable amount of time, after which it disappears. An example of an STB channel overlay is shown in FIG. 5. Some other examples for other MVPD channel banners are shown in FIGS. 14A-C.

A template is basically an image that masks out all the information on the banner, such that this mask matches all the overlays displayed on the TV buffer irrespective of the data that it contains. For example, the template 1900 is a ‘template’ image for an MVPD banner (e.g., a COX® banner). In one example, if an image is obtained from the video buffer, the overlay portion is cropped out and areas that show channel specific information are masked, it would exactly match the template (e.g., template 1900). Based on this, in one embodiment the TV device 220 (FIG. 2) may determine if the TV Frame buffer contains a template and also uniquely identify the type of STB it is connected to. Additionally, a template may be used for OCR for specific parts of the TV Frame buffer to recognize the information on the banner.

In one example, if all the information banner templates are stored in a database, the system may detect if there is a banner on the current screen. However, there is a significant sum of MVPD's and STB models. User interfaces from different MVPDs and different STBs may be very different. Even user interfaces from the same MVPD may vary from time to time. It is extremely expensive to collect all the information banners manually. Therefore, one embodiment automatically generates the user interface (UI)-based information banner.

In order to create a template, a plethora of images have to be captured from the TV Frame buffer, and all the information that is being displayed has to be determined for masking it out. In order to deploy such kind of a solution in the US market, there would be a need to travel all around the US to collect images from different STB's with different channel banners. Also MVPD changes to overlays would manually have to be monitored.

In one embodiment, a system is implemented in which the Information banner template is generated automatically and may be used to detect the Information banner on the current screen with little or no user intervention.

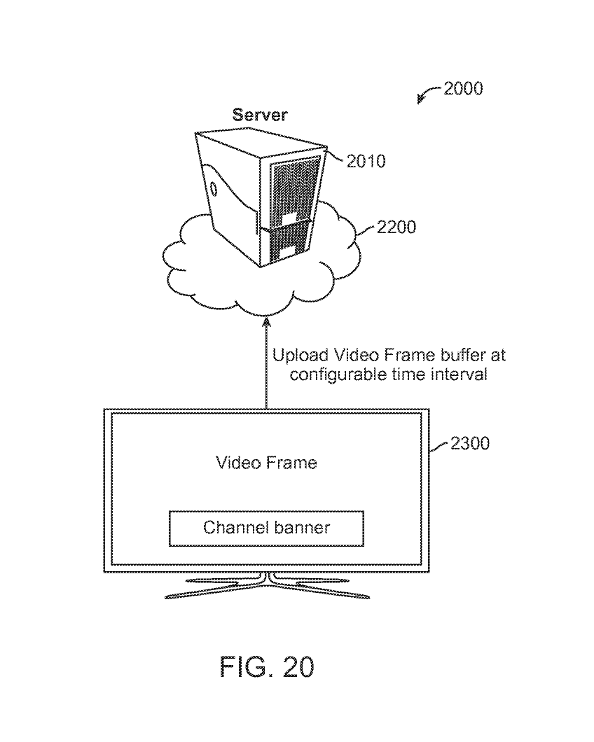

FIG. 20 shows an example system 2000 for automatically creating channel banner templates, according to an embodiment. In one example, the system includes a video displaying device (VDD) 2030 (e.g., TV device 220, FIG. 2) that displays a video frame with a channel banner, and a server 2010 that may be implemented in a cloud environment 2020. In one example, the TV device 2030 uploads a video frame buffer at configurable time intervals (e.g., periodic, event based, etc.) to the server 2010. In one example, the VDD 2030 sends its unique ID along with the video frame capture for the server to differentiate between different video displaying devices.

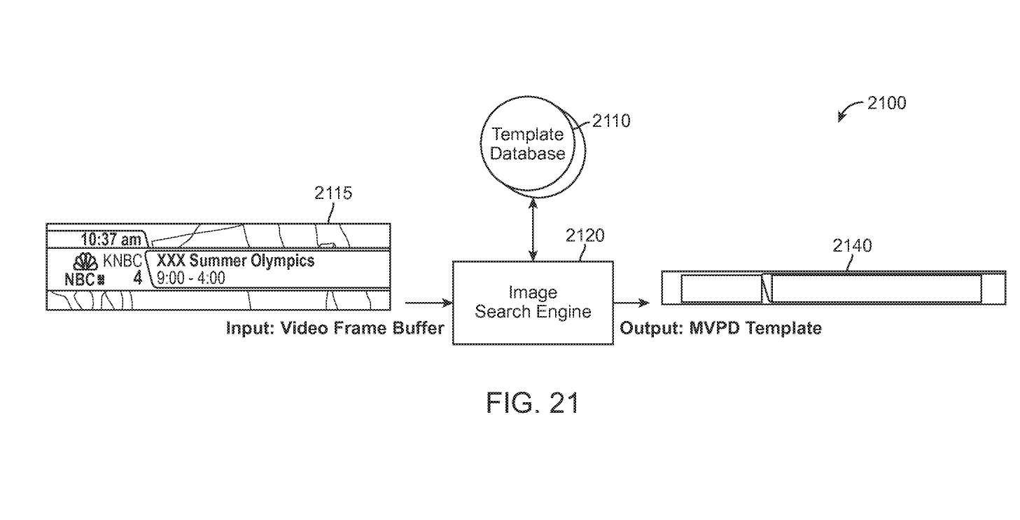

FIG. 21 shows an example system flow 2100 for automatically creating channel banner templates, according to an embodiment. In one embodiment, the input frame buffer 2115 from the VDD 2030 (FIG. 20) to the image search engine module 2120 (e.g., in a server, cloud-based service, etc.) that uses templates from the template database 2110 in order to determine and output the correct MVPD template 2140. In further detail, in one embodiment once the server 2010 (FIG. 20) receives the video frames 2115 it performs the following using the image search engine module 2120:
1. The server 2010 starts by figuring out if the images received in the video frame buffer 2115 contain a channel banner or not.
2. Once the server 2010 determines that it has found a video frame with the channel banner, the server 2010 runs these video frame images into the image search engine module 2120 to see if it matches with an existing template in the server database 2110.
3. If a match is found, the matched template is downloaded by the VDD 2030. Once the template is downloaded by the VDD 2030, the VDD 2030 only sends Video frames to the server 2010 only if it has a banner (the VDD 2030 performs a pixel comparison to determine whether the Video buffer has a banner or not). In one example, these video frames are sent to a different service (e.g., banner configuration service).
4. If not, the server 2010 senses this as a new banner and starts the template creation process. Following are the steps performed by the server 2010 for creating a new template:
   i) Perform image comparison between all images uploaded by the VDD 2030.
   ii) The resultant images would display parts that are common between the two images being compared. In case of images containing the channel banners, the channel banner portion is the common part.
   iii) Based on a threshold, images that might contain a banner are separated out from images that do not.
   iv) Once a few of these images are obtained, i.e. with channel banners, it is able to determine the outlines of the banner in the resultant image.
   v) Next edge detection is performed on these images to determine the edges of the banner.
   vi) Once the images with the edges are detected, corner detection is performed. After running the corner detection, all potential corners of the channel banner are obtained. The outermost corners are selected in order to select the final banner co-ordinates.
   vii) Up to this point, the coordinates of the banner are identified. Next, the coordinates within the banner that contain text are detected. These coordinates are used to extract channel information using OCR.
   viii) A histogram along both axis of the banner is generated. Based on a peak threshold, the areas along each axis that may have text are determined.
   ix) For each peak along an axis (e.g., x) the peaks along the other axis (y) are determined and coordinates are plotted. Based on the previous operations, an area (coordinates of regions) within the template that contain text are known.
   x) At this time the Template creation process is completed and the system is ready to identify the frames that have banners and the regions within the banner that contain channel specific information. All this information is uploaded to the template database 2110 and the process continues with step 1.

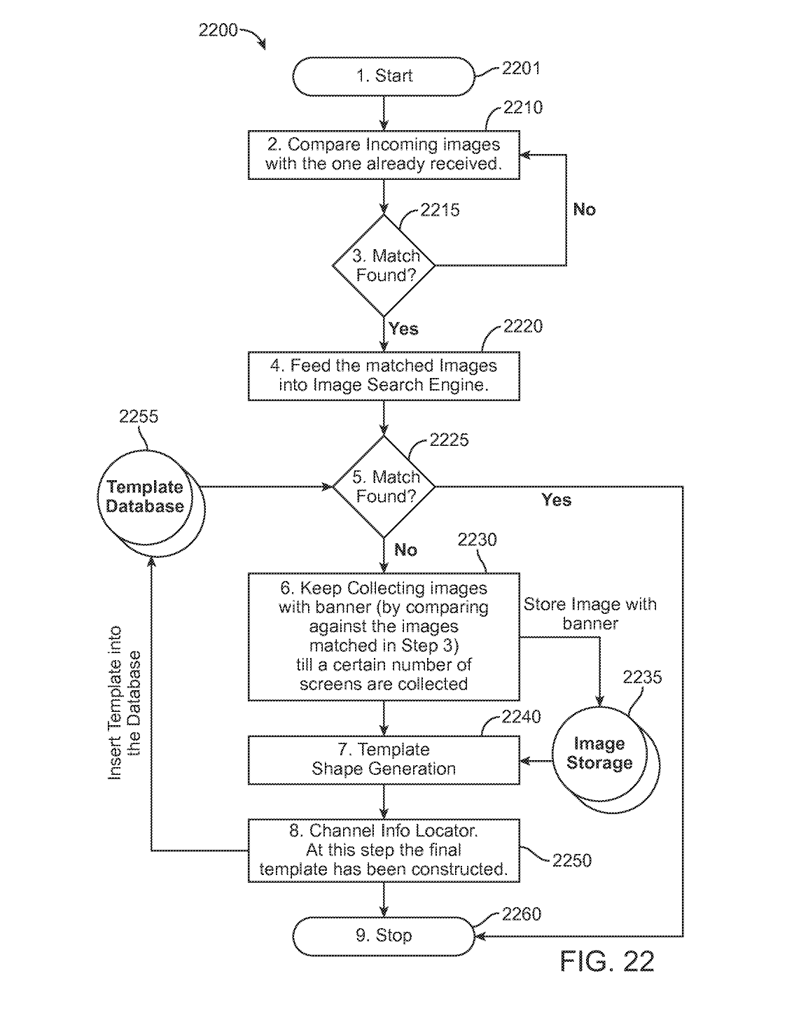

FIG. 22 shows an example high-level flow diagram 2200 for automatically creating channel banner templates, according to an embodiment. The process 2200 begins with block 2201, where the system receives video frames from a buffer of the VDD 2030 (FIG. 20). In one example, in block 2210 the server 2010 compares the incoming images with images already received. In block 2215, it is determined if a match has been found. If no match has been found, the process 2200 continues to block 2210.

If a match has been found in block 2215, the process 2200 continues to block 2220, where the matched images are fed into the image search engine module 2120. In one embodiment, templates from the template database 2110 are received in block 2255 and in block 2225 it is determined if a match is found. If it is determined that a match has been found in block 2225, the process 2200 proceeds to block 2260 and ends. Otherwise, in block 2230 the process 2200 keeps collecting images with banners (by comparing against the images matched in block 2215 until a particular (e.g., predetermined, periodic, based on a threshold, etc.) number of screen images are collected.

In block 2235 images with banners are stored into an image storage repository, database, etc. In block 2240, the images from the image storage block 2245 are used for template shape generation. In block 2250, a channel Info locator operation is performed, and the final template has been constructed, and the final template is inserted into the template database 2255. The process 2200 then stops at block 2260.

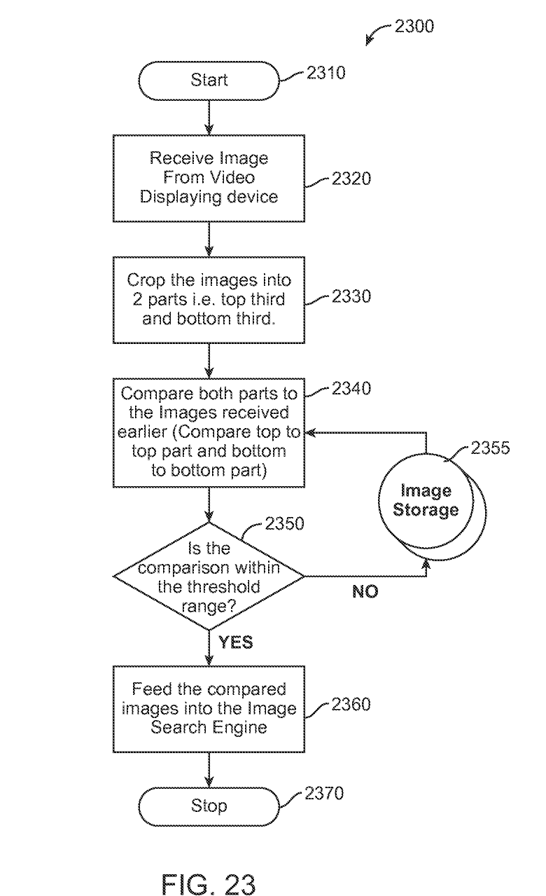

FIG. 23 shows an example flow diagram 2300 for details of determining if video buffer images contain a channel template or not, according to an embodiment. As previously described, the system starts by trying to figure out whether the video buffer image received contains a template or not. For this, the server 2010 (FIG. 20) performs image comparisons between all the images received from the VDD 2030. In one embodiment, it is with an extremely high probability that the channel banner resides in the top one third or the bottom one third part of the screen images. Therefore, in one example the top one third and the bottom one third portions of the screen images are cropped for comparison on the server 2010. In one embodiment, all incoming images are compared against the images already collected, i.e. the top one third portion and the bottom one third portion.

Assuming the banner occupies a significant portion of the top one third or the bottom one third portion of the image, the server 2010 sets a threshold range for pixel comparison, i.e. if the number of pixels matched is within the threshold range, the server 2010 assumes the images that have been compared have a channel banner present (absolute match of, for example, two screens may indicate corner cases, such as two black screens; therefore a threshold range is used to eliminate these corner cases). At this point both the compared images are fed into the image search engine module 2120 to determine a match with the existing template.

In one embodiment, the flow is described with reference to process 2300 below. In one embodiment, process 2300 starts with block 2310 and proceeds to receive one or more images from the VDD 2030 (FIG. 2) in block 2320. In block 2330, the received images are cropped into two portions (i.e., the top third and bottom third). In block 2340, both portions are compared to previous received images obtained from the image storage in block 2355 (i.e., the top and bottom portions are compared to previous top and bottom portions).

In block 2350, it is determined whether the comparison is within the threshold range. If the comparison is not within the threshold range, the images are stored in the image storage in block 2355. If the comparison is within the threshold range, process 2300 proceeds to block 2360. In block 2360, the compared images are fed into the image search engine module 2120 and the process 2300 proceeds to stop at block 2370.

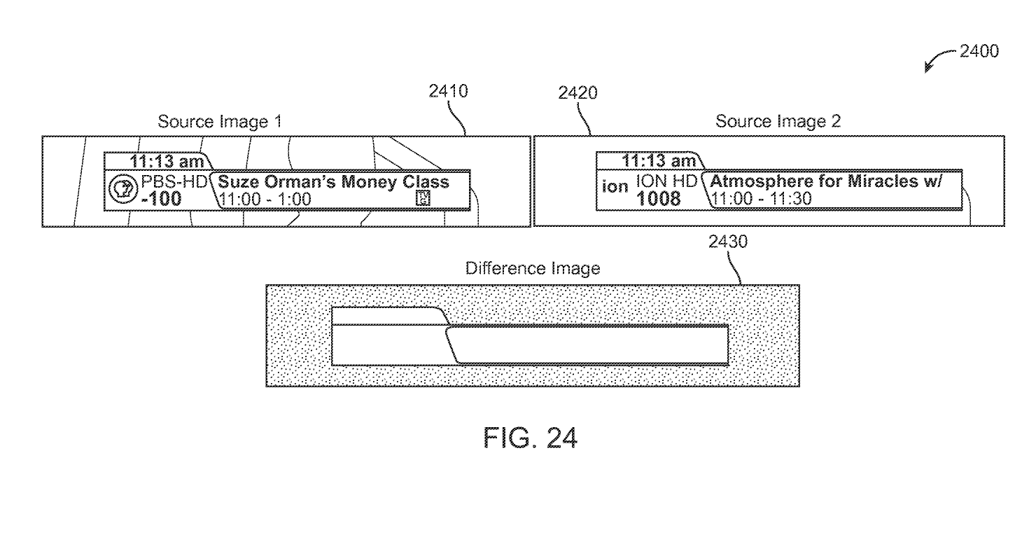

FIG. 24 shows example images 2400 with channel banners and a difference image. In one embodiment, the example source image 2410 is compared with the example source image 2420 (i.e., comparing the bottom one third portion) with a channel banner. The server 2010 (FIG. 20) then runs these source images into the image search engine module 2120 (FIG. 21) to see if it matches with an existing template in the server template database 2110. The difference image 2430 is used for the comparison.

FIG. 25 shows a block diagram 2500 for an image search engine module 2530 (similar to the search engine module 2120, but shown in further detail) used for automatically creating channel banner templates, according to an embodiment. In one example, the image search engine module 2530 includes a query image module 2540, a feature extraction (for pixel matrix) module 2550, a similarity measurement module 2560 (pixel by pixel comparison) and result image module 2570 that outputs the channel template 2580. In one example, the input images 2520 are received from a VDD 2030 (FIG. 20) and banner templates are received from the banner template database 2510 (similar to the template database 2110). In one embodiment, the template database 2510 contains a list of template images (which have already been created) and a corresponding configuration file that contains details regarding where on the screen the banner is located (coordinates of the template), and where are the portions that contain channel information. In one example, the data of the configuration file is used by the feature extraction module 2550 to crop the banner and mask the information portions from the input image 2520.

In one embodiment, the server 2010 (FIG. 20) receives the video frame image 2520 from the VDD 2030 in the query image module 2540. The query image module 2540 feeds the video frame image 2520 into the feature extraction module 2550. The feature extraction module 2550 also receives metadata information from the template database 2510 in the form of the configuration file corresponding to the template image being compared with. The feature extraction module 2550 performs processing on the input image 2520 (i.e., cropping the banner area and masking the channel information areas, and producing the features for comparison (e.g., pixel matrix)). Once the feature extraction module 2550 processing is completed, the image features output to the similarity measure module 2560.

The similarity measure module 2560 performs a similarity comparison based on the features of the image received and the image from the template database 2510 (e.g., pixel by pixel comparison based on the pixel matrix). The comparison yields a similarity value. If the similarity value is within the acceptable range, the image search engine module 2530 declares it found a match. If a match is found, the matched template is downloaded by the VDD 2030. Once the template is downloaded by the VDD 2030, it only sends video frames if it has a banner (the VDD 2030 performs a pixel comparison to determine whether the Video buffer has a banner). These video frames are sent to a video frame service. If a match was not found, the image search engine module 2530 figures out that the template does not exist and a new channel banner template is created. In one example, the new channel banner template is detected and created in two steps, Automatic Template Shape Generation and Automatic Channel Information Location Generation. Since the specific UI is from the STB, some prior knowledge is obtained as follows.
1) For an area, during a period, the UI template for the same MVPD is consistent.
2) The information banner is overlapped on a part of the VDD 2030 screen, and covers partial program content (depending on the transparency of the banner).
3) The information banner generally occupies the top or bottom screen portion, less than one third of the whole screen.
4) The information banner remains for a few seconds after a channel change, and then disappears.
   Based on the prior knowledge, the TV channel information templates are automatically generated.

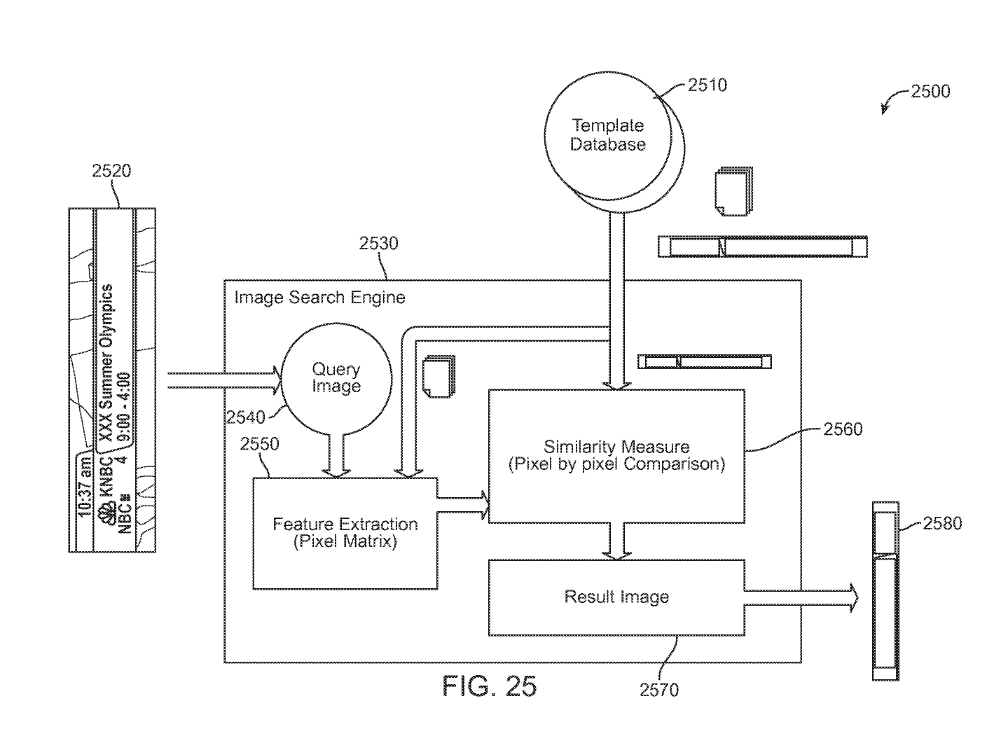

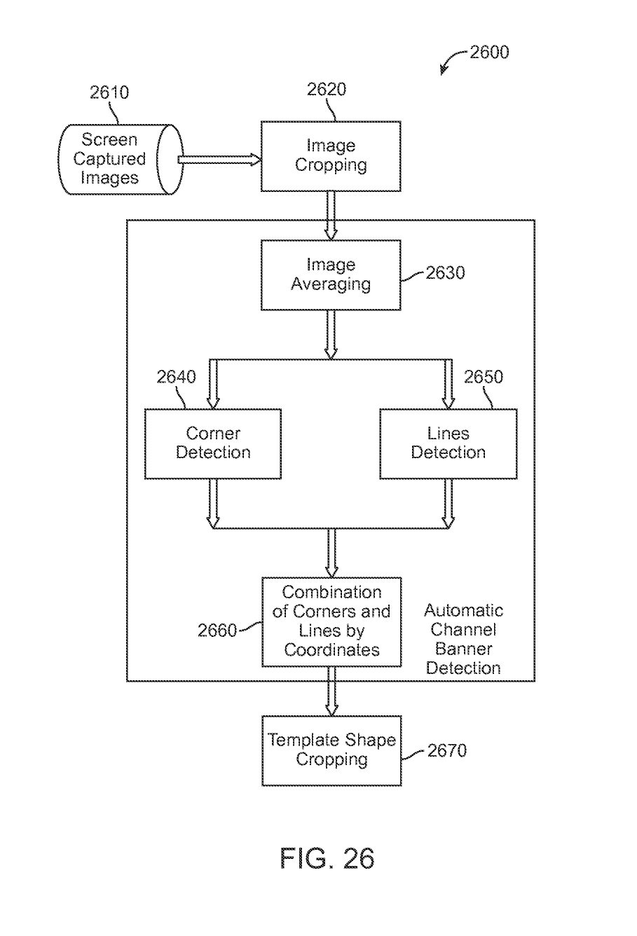

FIG. 26 shows a flow diagram 2600 for automatic channel banner template shape generation, according to an embodiment. In block 2610 screen captured images are sent to the image search engine module 2530 (FIG. 25). In block 2620, image cropping is performed. Statistically, it is with high probability that the information banners are on the top or bottom part of the screen. Therefore, the top and bottom portions of the captured screen images are cropped first. In block 2630, image averaging is performed. For those cropped images, the channel information banner is the common portion, while the background from different program content is uncommon and random. Theoretically, if there are an extremely large number of images, the uncommon part of the average image becomes white noise without any useful information and the common portion is reserved and emphasized. Therefore, in one example, image averaging for the cropped images is performed and achieves an average image.

In one example, in block 2650 lines detection is performed. On the averaged image, since the banner is reserved, the edges of the banner and some lines inside of the banner will have the stronger response to the line detector compared with the background content. Therefore, in one embodiment lines detection is performed to obtain the edges of the banners. In one embodiment, in block 2640, corners detection is performed. Similarly as the lines detection is performed on the averaged image, the corners detection is performed on the averaged image. Since the banner is reserved, the corners of the banner shape are the most salient. Therefore, in one example the corners detection is performed and the corners with the strongest response to the detector are maintained. In block 2660 the results from the lines detection block 2650 and the corners detection 2640 are combined (by coordinates).

In one embodiment, in block 2670 template shape cropping (generation) is performed. In one example, by combining the detected lines and corners based on one or more rules, the template shape may be obtained. For example, basic polygon rules may be applied. For each detected point, if there are two lines passing it or its K-pixel neighbor and the two lines are in different directions, it is selected as one of the vertices. Connecting the selected corners along the detected lines then produces the final template shape.

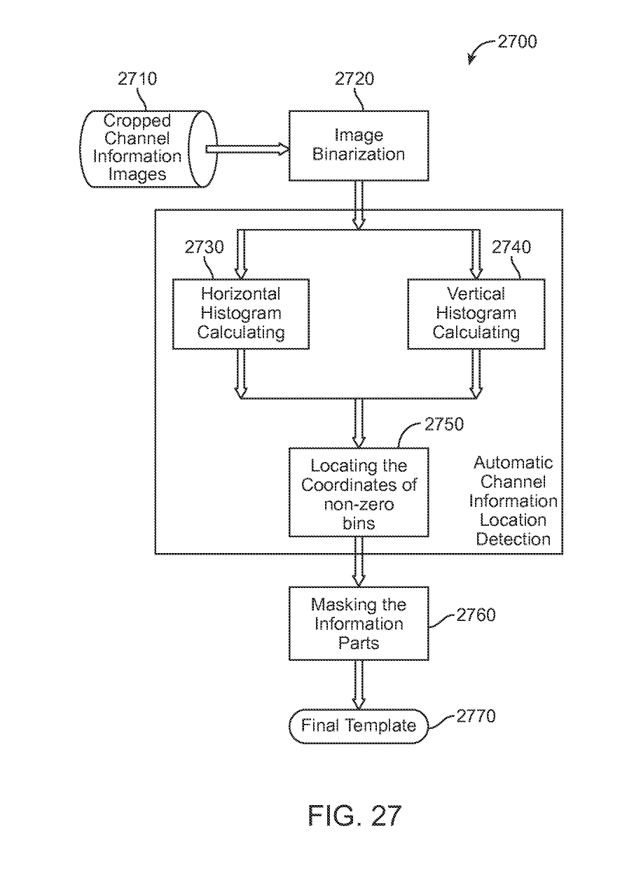

FIG. 27 shows a flow diagram 2700 for automatic channel information location generation, according to an embodiment. With the coordinates of corners and lines between corners, the channel banner may be cropped from the image in block 2710. In one embodiment, the cropped channel information image is binarized in block 2720. In one example, for those banners with light-colored background, pixels with information portions are 0 (black) and pixels with non-information portions are 255 (white). For those banners with a dark-colored background, pixels with information portions are 255 (white). In order to process these information portions in the same manner, images with dark-colored background are negated.

In one embodiment, in the binary image, the black pixel on each position is calculated along horizontal and vertical directions in block 2730 and block 2740, respectively, which produce two histograms. In one example, in block 2750 the coordinates of the non-zero bins of the two histograms are located. According to the two histograms, the pixel positions are marked where the corresponding bins are not zero because the non-zero portions show the locations with information varying from channel to channel. Those varying portions will be the information portions including channel number, call sign, program information, current time, channel logo, etc., which are the potential portions for OCR.

In one example, the process 2700 is performed on a number of images. For each possible information portion, the image is cropped and an OCR is performed on it. In one example, the possible portions are treated as four categories:
1) For some channels, channel logos are present. But some channels do not have logos. In one example, for those logo portions, with OCR, sometimes meaningless characters result, but not at some other times. Therefore, those portions are not maintained for OCR, but are masked in the banner template in block 2760.
2) For some cropped portions, there is always no OCR results, which implies empty portions. Therefore, in one example those portions are not maintained in masking in block 2760.
3) Further, some portions always provide the same OCR result, which implies the same information portion of the MVPD (e.g., MVPD logo). Those portions are not masked in block 2760 in the final template provided in block 2770.
4) The portions with different OCR results are masked in the banner template in block 2760, and their coordinates are saved in the database to mark the OCR target areas for the same program source.

After masking the corresponding portions in block 2760, the final banner template image is provided in block 2770. In one example, the newly generated banner template image and the coordinates of the OCR portions are stored in the banner template database 2510 (FIG. 25).

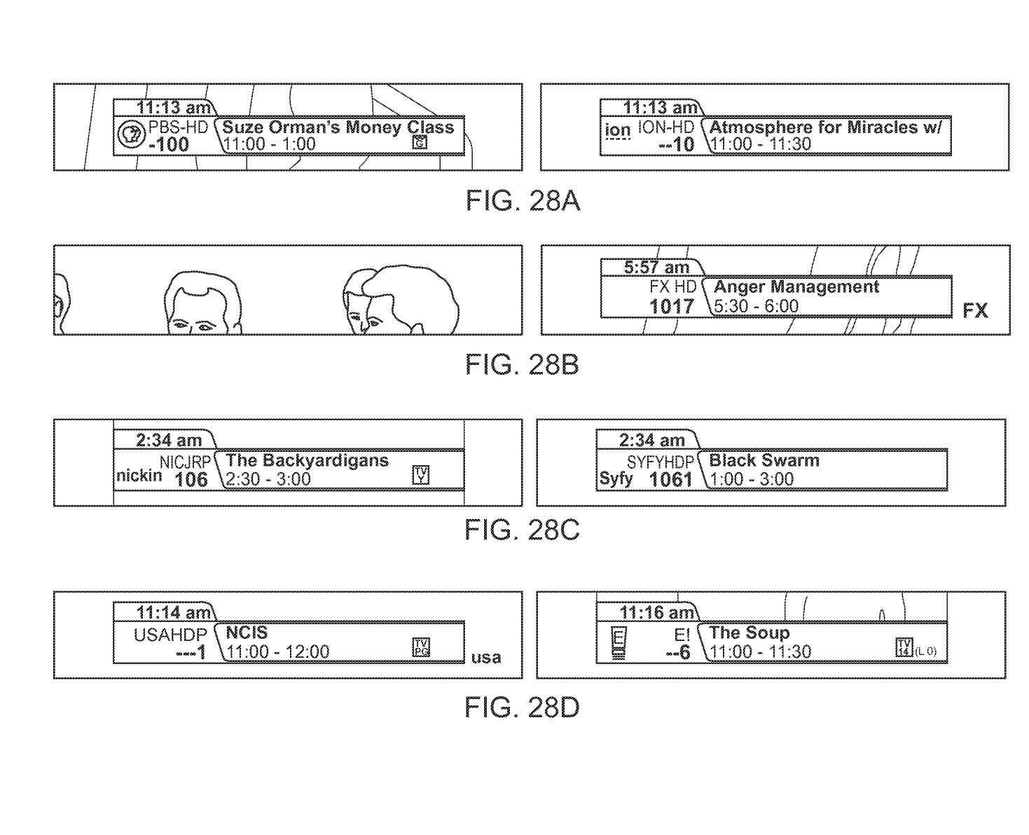

FIGS. 28A-D show examples of source images and the associated cropped images (to the right), according to an embodiment. The examples illustrated show the results to the right of the source image after image cropping, where several cropped images with and without banners are shown as examples.

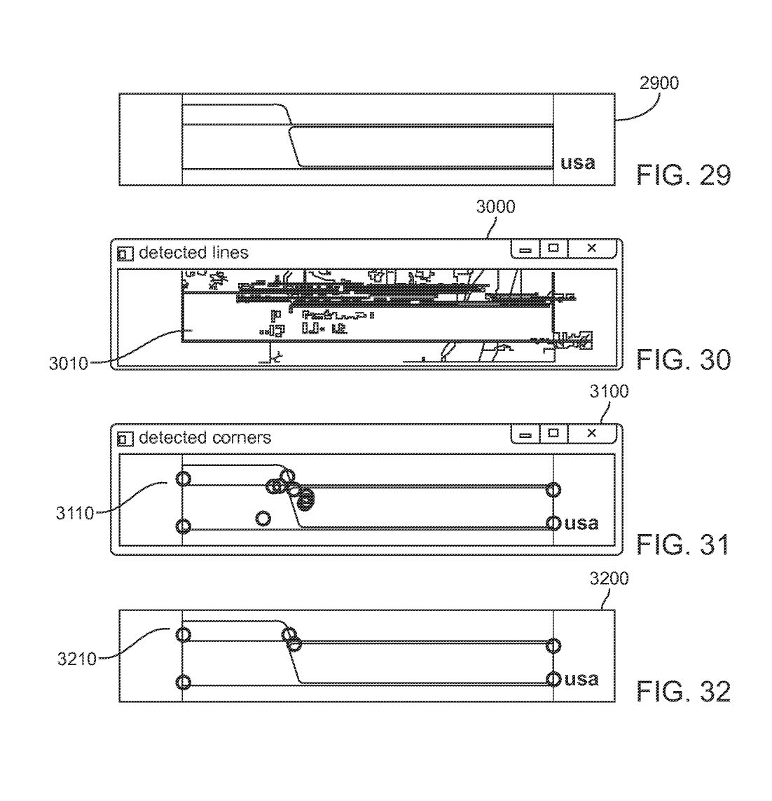

FIG. 29 shows an example averaged image 2900 of cropped images, according to an embodiment. In one example, using a limited number of images and some cropped images without banners, the common banner portion can still be reserved. The averaged image of previous cropped images is shown in the example image 2900.

FIG. 30 shows an example image 3000 with detected lines 3010, according to an embodiment. On the averaged image, a Hough line transform, which is a traditional line detection method, may achieve good results. The example image 3000 with detected lines 3010 by performing a Hough line transform is shown in FIG. 30.

FIG. 31 shows an example image 3100 with detected corners, according to an embodiment. From the averaged image, the detected corners may be obtained. As shown, the detected corners are shown with markings 3110.

FIG. 32 shows an example channel banner template image 3200 generated from detected corners and lines with the coordinates marked as 3110, according to an embodiment.

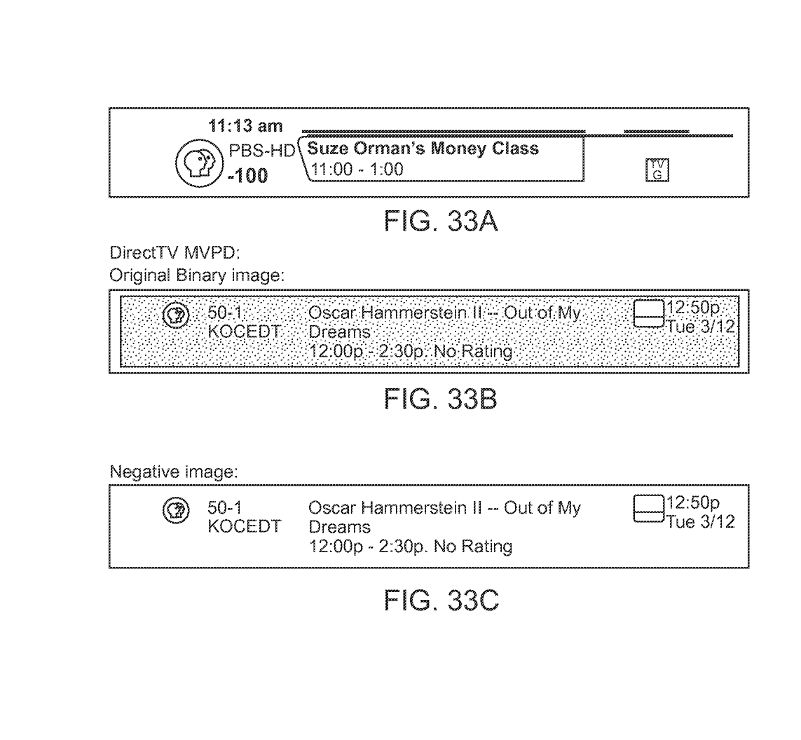

FIGS. 33A-C show examples of binary template-shape cropped images, according to an embodiment. After the template corners and edge lines have been detected, the template-shape image may be cropped, and then binarized. FIGS. 33A-C show examples of binary template-shape cropped images for a COX® MVPD, DirecTV® MVPD (Original Binary image), and a negative image.

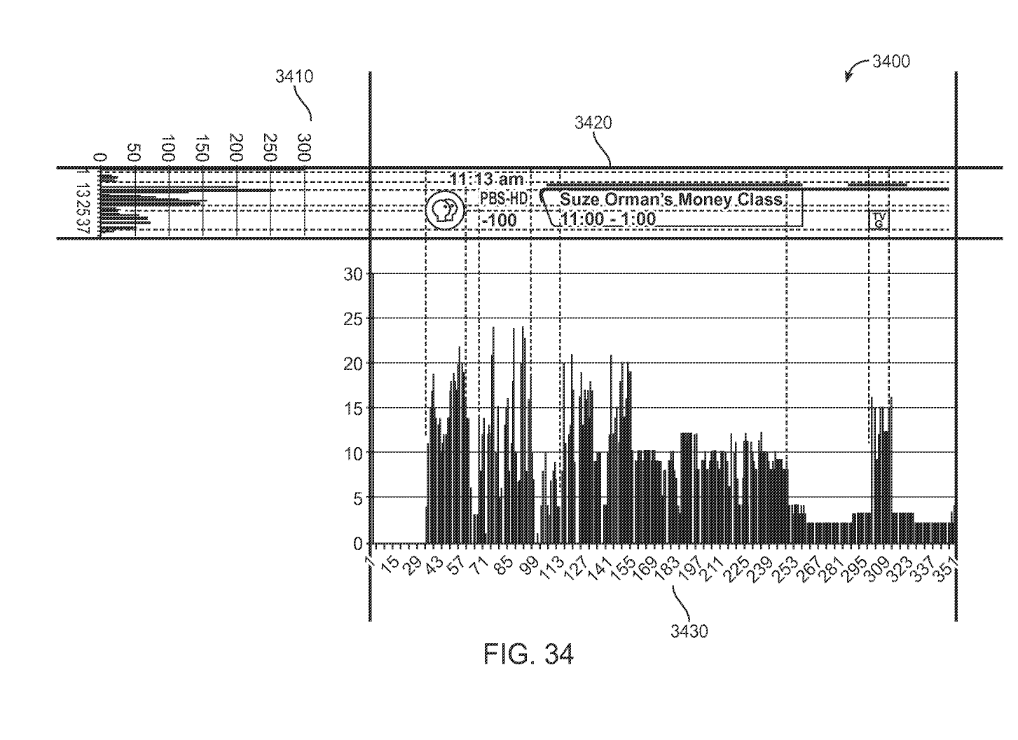

FIG. 34 shows an example histogram 3400 of different portions 3410, 3420 and 3430 within a channel banner, according to an embodiment. Inside the banner, the text portions are located by histograms on the binary images, as shown in the histogram 3400 for an example COX® MVPD.

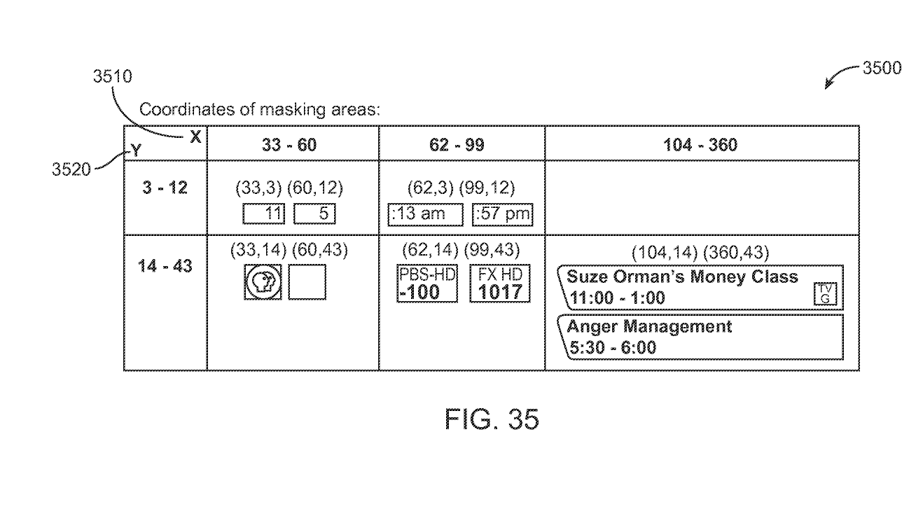

FIG. 35 shows coordinates 3500 for masking areas for the histogram of FIG. 34, according to an embodiment. In one example, the coordinates are shown for the x axis 3510 ad the y axis 3520.

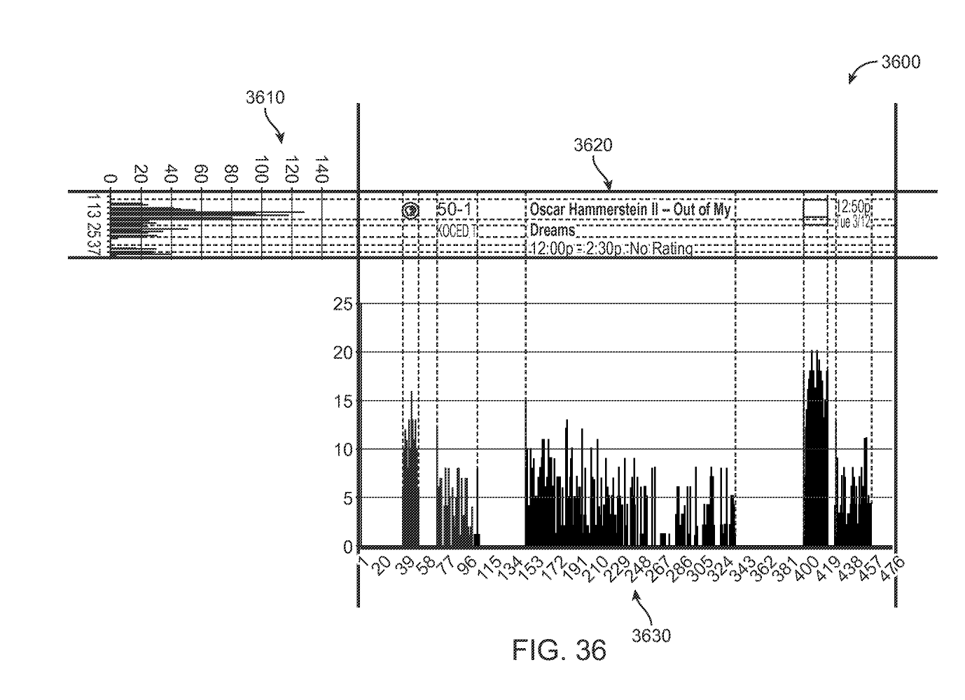

FIG. 36 shows another example histogram 3600 of different portions 3610, 3620 and 3630 within a channel banner, according to an embodiment. Inside the banner, the text portions are located by histograms on the binary images, as shown in the histogram 3600 for an example DirecTV® MVPD.

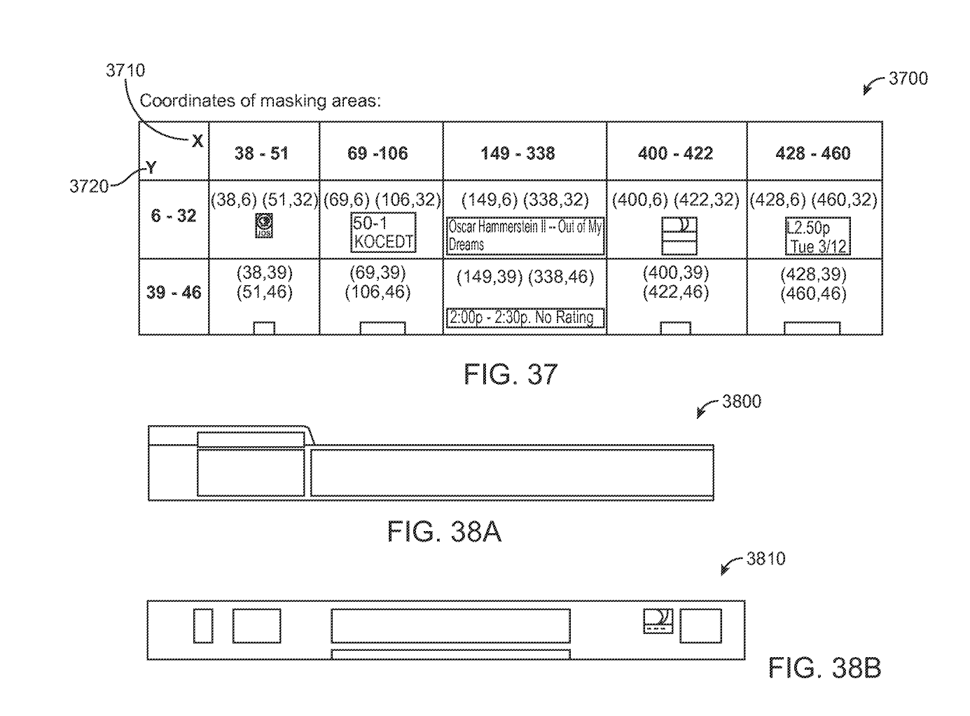

FIG. 37 shows coordinates 3700 for masking areas for the histogram of FIG. 36, according to an embodiment. In one example, the coordinates are shown for the x axis 3710 ad the y axis 3720.

FIGS. 38A-B show examples of final channel banner templates that were automatically created, according to an embodiment. After masking the detected text portions, the final template may be obtained. In one example, channel banner template 3800 is obtained for a COX® MVPD. In another example, channel banner template 3810 is obtained for a DirecTV® MVPD. In one embodiment, once the final templates are obtained, the template areas are cropped from incoming frames, the relevant portions are masked and these are compared against the stored templates in order to check whether the frame has a channel banner or not.

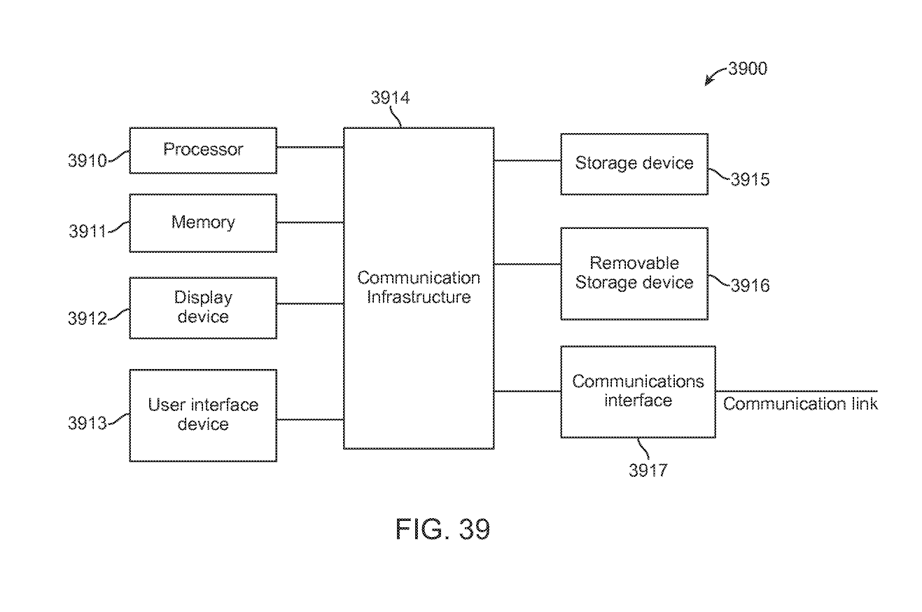

FIG. 39 is a high level block diagram showing a computing system 3900 comprising a computer system useful for implementing an embodiment. The computer system 3900 includes one or more processors 3910, and can further include an electronic display device 3912 (for displaying graphics, text, and other data), a main memory 3911 (e.g., random access memory (RAM)), storage device 3915, removable storage device 3916 (e.g., removable storage drive, removable memory module, a magnetic tape drive, optical disk drive, computer readable medium having stored therein computer software and/or data), user interface device 3913 (e.g., keyboard, touch screen, keypad, pointing device), and a communication interface 3917 (e.g., modem, a network interface (such as an Ethernet card), a communications port, or a PCMCIA slot and card). The communication interface 3917 allows software and data to be transferred between the computer system 3900 and external devices. The system further includes a communications infrastructure 3914 (e.g., a communications bus, cross-over bar, or network) to which the aforementioned devices/modules are connected as shown.

Information transferred via communications interface 3917 may be in the form of signals such as electronic, electromagnetic, optical, or other signals capable of being received by communications interface, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

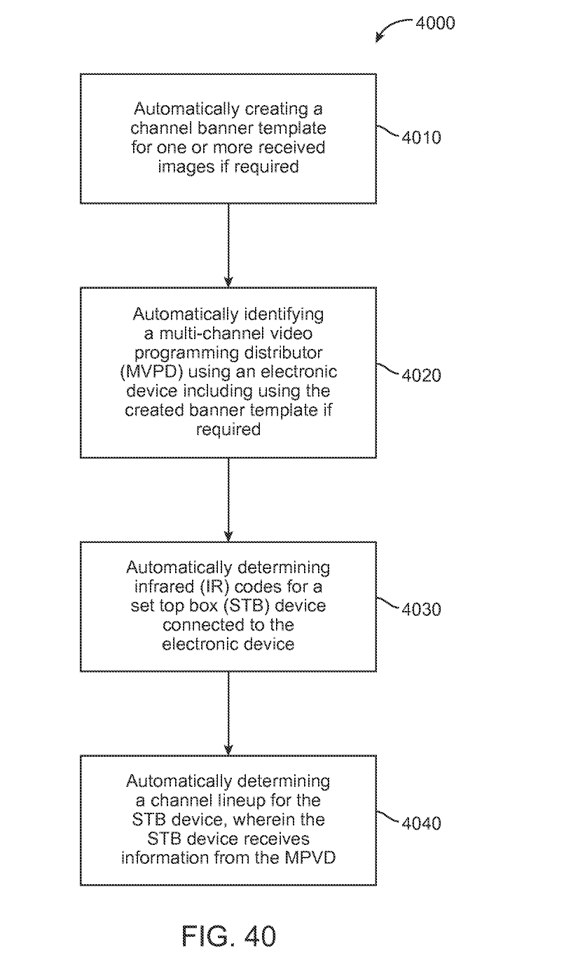

FIG. 40 is a flow diagram 4000, according to an embodiment. In one embodiment, in block 4010, a channel banner template is automatically created for one or more received images if required. In block 4020, an MVPD is automatically identified using an electronic device (e.g., a TV 220, FIG. 2, a VDD 2030, FIG. 20) including using the created banner template if required. In block 4030, IR codes for an STB device connected to the electronic device are automatically determined. In block 4040, a channel lineup for the STB device is automatically determined. In one embodiment, the STB device receives information from the MPVD. In one example, the process 4000 may implement any of the preceding flow diagrams, systems and components as described above.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

1. A method comprising:
automatically identifying a multi-channel video programming distributor (MVPD) using an electronic device; and
automatically determining infrared (IR) codes for a set top box (STB) device connected to the electronic device, wherein the STB device receives information from the MVPD.

2. The method of claim 1, wherein automatically identifying the MVPD comprises using at least one of: reverse Internet protocol (IP) lookup, searching known MVPDs based on zip code, on screen display detection (OSD), template matching and optical character recognition.

3. The method of claim 2, wherein a plurality of display templates are used for determining at least one match with a particular screen display for the STB device.

4. The method of claim 3, wherein determining at least one match comprises channel banner detection.

5. The method of claim 4, wherein channel banner detection comprises classification of at least one channel banner based on at least one of screenshot global features, screenshot key differentiating points matching and template matching.

6. The method of claim 5, wherein the global features comprise features of a channel banner that discriminate channel banner screenshots from non-banner screenshots.

7. The method of claim 5, wherein the screenshot key differentiating points matching comprises extracting key differentiating points from a current screenshot and comparing the extracted key differentiating points with a predetermined key differentiating points matrix for all possible MVDPs.

8. The method of claim 7, wherein key differentiating points comprise coordinates on a template that do not change.

9. The method of claim 8, further comprising creating a vector from the extracted key differentiating points, wherein the vector comprises key value pairs, a key represents a unique identification (ID) associated with a MVPD that a channel banner belongs to, and a value represents a key differentiating points threshold and a pointer to a key differentiating points linked list.

10. The method of claim 5, wherein template matching comprises a pixel-by-pixel matching between a screenshot and at least one graphical user interface (GUI) template for at least one MVPD.

11. The method of claim 2, wherein automatically determining IR codes for the STB device comprises:
initiating an IR input from the electronic device using an IR blaster device;
computing a cost function of each IR input from a table comprising detectable key codes;
removing IR key code sets from the table based on conflicts; and
normalizing probability of remaining IR key code sets in the table and computing the cost function for remaining IR inputs.

12. The method of claim 11, wherein the computing and the removing are repeated until one IR key code set remains in the table, and the one remaining IR key code set comprises a correct IR key code set for the STB device.

13. The method of claim 1, further comprising:
automatically determining a channel lineup for the STB device that receives information from the MVPD.

14. The method of claim 1, wherein the electronic device is a television device.

15. A method comprising:
automatically identifying a multi-channel video programming distributor (MVPD) using an electronic device; and
automatically determining a channel lineup for a set top box (STB) device that receives information from the MVPD.

16. The method of claim 15, wherein said automatically determining the channel lineup comprises using an infrared (IR) blaster device to tune to channels using the STB device, and the channels have different screenshots.

17. The method of claim 16, wherein automatically identifying the MVPD comprises using at least one of: reverse Internet protocol (IP) lookup, searching known MVPDs based on zip code, on screen display detection (OSD), template matching and optical character recognition (OCR).

18. The method of claim 17, wherein a plurality of display templates are used for determining at least one match with a particular screen display for the STB device.

19. The method of claim 18, wherein determining at least one match comprises channel banner detection.

20. The method of claim 19, wherein channel banner detection comprises classification of at least one channel banner based on at least one of screenshot global features, screenshot key differentiating points matching and template matching.

21. The method of claim 17, wherein automatically determining the channel lineup comprises determining discriminating channels and non-discriminating channels, a discriminating channel comprises a channel that is distinguishable between potential channel lineups, and a non-discriminating channel is not distinguishable between the potential channel lineups.

22. The method of claim 21, wherein automatically determining the channel lineup further comprises:
removing all non-discriminating channels from the potential channel lineups;
computing a function of each channel from a table comprising the potential channel lineups;
removing potential channel lineups from the table based on conflicts determined from tuning to different channels using the IR blaster; and
normalizing probability of remaining potential channel lineups and re-computing the function for remaining potential channel lineups from the table.

23. The method of claim 22, wherein the computing and the normalizing are repeated until one channel lineup remains in the table, and the one remaining channel lineup comprises a correct channel lineup for the STB device.

24. The method of claim 15, further comprising:
automatically determining infrared (IR) codes for the STB device connected to the electronic device.

25. A method comprising:
transmitting video frames to a server device;
determining if the video frames contain a channel banner;
determining if at least one determined channel banner is a match with at least one existing template;
receiving, by an electronic device, a matched template; and
automatically creating a channel banner template if a match is not determined to exist.

26. The method of claim 25, wherein automatically creating the channel banner template comprises:
performing image comparison between images uploaded by the electronic device to the server device for determining common display portions between images being compared;
based on a threshold, separating images that potentially contain a banner from the uploaded images; and
analyzing the separated images for creating the channel banner template.

27. The method of claim 26, wherein the analyzing the separated images comprises:
averaging the separated images to form a resultant image;
performing edge detection on the averaged image for determining channel banner edges;
performing corner detection for selecting outermost corners for selecting channel banner coordinates; and
performing text detection for selected channel banner coordinates.

28. The method of claim 27, wherein performing text detection comprises:
creating a histogram along a first axis and a second axis of the separated images; and
determining areas along the first axis and the second axis for potential text detection based on a peak threshold.

29. The method of claim 25, wherein the channel banner comprises a multi-channel video programming distributor (MVPD) channel banner.

30. A method comprising:
automatically creating a channel banner template for one or more received images if required;
automatically identifying a multi-channel video programming distributor (MVPD) using an electronic device including using the created banner template if required;
automatically determining infrared (IR) codes for a set top box (STB) device; and
automatically determining a channel lineup for the STB device.
